(19) United States
(12) Patent Application Publication
(10) Pub. No.: US 2026/0129645 A1
(43) Pub. Date: May 7, 2026

(54) UPLINK ENHANCEMENT FOR EXTENDED REALITY AND CLOUD GAMING SERVICES

(71) Applicant: Google LLC, Mountain View, CA (US)

(72) Inventors: Chih-Hsiang Wu, Taipei (TW); Abdellatif Salah, Cambridge (GB); Shiangrung Ye, Taipei (TW)

(21) Appl. No.: 19/122,703

(22) PCT Filed: Oct. 31, 2023
(86) PCT No.: PCT/US2023/036526

§ 371 Date: Apr. 18, 2025

Related U.S. Application Data
(60) Provisional application No. 63/382,415, filed on Nov. 4, 2022.
(60) Provisional application No. 63/504,063, filed on May 24, 2023.

(51) Int. Cl. H04W 72/21; H04W 72/115

(52) U.S. Cl. CPC H04W 72/21; H04W 72/115

(57) ABSTRACT

Methods and techniques disclosed herein enhance uplink scheduling for extended reality (XR) to support XR traffic with its stringent latency and reliability requirements. The XR traffic has large packets with variable sizes arriving quasi-periodically. An example method by a user equipment (UE) includes receiving (2302), from a network entity, a physical uplink shared channel (PUSCH) configured grant (CG) indicating first PUSCH resources in plural PUSCH occasions for each traffic period. The UE transmits (2314 or 2316), to the network entity, a message indicating the UE usage of the plural PUSCH occasions in a current traffic period when a first data volume transmissible using the first PUSCH resources is different from a second data volume transmissible using second PUSCH resources assessed by the UE device for transmitting data in the current traffic period.

### CROSS-REFERENCE TO RELATED APPLICATIONS

This application claims the benefit of and priority to the U.S. Provisional Application Ser. No. 63/382,415, titled “UPLINK ENHANCEMENT FOR EXTENDED REALITY AND CLOUD GAMING SERVICES,” filed on Nov. 4, 2022, and the U.S. Provisional Application Ser. No. 63/504,063, titled “UPLINK ENHANCEMENT FOR EXTENDED REALITY AND CLOUD GAMING SERVICES,” filed on May 24, 2023, the disclosures of which are incorporated herein by reference in their entirety.

### FIELD

This disclosure relates to wireless communications and, more particularly, to managing wireless communications with large and variable data rates.

### BACKGROUND

XR stands for eXtended Reality, which is an umbrella term that covers Augmented Reality (AR), Virtual Reality (VR) and Mixed Reality (MR). In virtual reality, the user is fully immersed in a virtual environment that is totally substituting the real environment by wearing a head-mounted device. Augmented reality augments the perception of the real environment with some virtual elements, so some virtual elements are overlaid on the perception of the real environment. The game Pokemon Go is one famous example of an AR game. Mixed reality is an extension of AR where the real and virtual elements may interact in real time. Cloud gaming runs video games on remote servers without the need for a gaming console or a high spec CPU and GPU to play these games. Cloud gaming streams a game like streaming a video, and the game may respond to the gamer commands and controls in real time.

Wireless AR/VR and wireless Cloud gaming offer better freedom of movement as wireless eliminates the geographical or behavioral restrictions and allows VR and AR users to move freely. Wireless AR/VR also enables new applications like remote education in immersive environment for remote areas not connected with good digital subscriber line (DSL) or optical fiber. Multiple XR scenarios and applications are deployed. Offline sharing of 3D objects consists of sharing 3D models or objects and 3D mixed reality scenes amongst users, e.g., using a phone equipped with a depth camera to capture an image in 3D and then share it with a contact. XR conferencing is another use case and include people interacting in virtual environment and sharing a 3D experience with each other and even presenting some content and discuss it with other people in the same conference.

XR data signals may include variable packet size. For example, when a video traffic is transmitted at 60 frames per second, not all frames occupy the same size. The frame size may be drawn from a truncated Gaussian distribution, such as having an average data rate and standard deviation varied based on video content and compression techniques. Jitter occurs when the packet size to be transmitted exceeds allowable bandwidth (e.g., available resources). Jitter may be drawn from a truncated Gaussian distribution and may also be variable relative to the variable packet size. To minimize latency, configured grant is often used as dynamic grant scheduling often comes with higher levels of latency. Therefore, given the nature of XR traffic and configured grant, jitter or substantial latency may be expected when uplink transmission resources are set at a level insufficient to handle volume surge. Likewise, the uplink transmission resources may be wasted if the XR traffic is on pause or not as heavy as expected. Either situation causes systematic inefficiency in uplink transmission resource scheduling.

### SUMMARY

The present disclosure discloses enhancement to the UL XR scheduling to support XR traffic with its stringent latency and reliability requirements. The XR traffic has large packets with variable sizes arriving quasi-periodically. New scheduling techniques and enhancements of the existing techniques are needed for the scheduling of the XR packets, hence improving the system capacity and supporting more users consuming the service simultaneously. The enhancements are also needed to address the latency and reliability limitations of the existing schemes.

For example, a user equipment (UE) receives, from a network entity, a physical uplink shared channel (PUSCH) configured grant (CG) indicating first PUSCH resources in plural PUSCH occasions for each traffic period. The UE assesses second PUSCH resources necessary for transmitting data in a current traffic period (such as XR data having variable rate). The UE transmits, to the network entity, a message indicating the UE modifies the plural PUSCH occasions in the current period when a first data volume transmissible using the first PUSCH resources is different from a second data volume transmissible using the second PUSCH resources.

### BRIEF DESCRIPTION OF THE DRAWINGS

FIG. 1A is a block diagram of an example system in which a distributed base station and/or a user equipment (UE) may implement the techniques of this disclosure for managing a radio connection of the UE during early data transmission (EDT);

FIG. 1B is a block diagram of an example base station including a central unit (CU) and a distributed unit (DU) of a distributed base station that may operate in the system of FIG. 1A;

FIG. 2 is a block diagram of an example protocol stack according to which the UE of FIGS. 1A-B may communicate with base stations;

FIG. 3 shows an example of the configuration of multi-PUSCHs per CG.

FIG. 4 shows an example of a CG configuration with multi-PUSCH occasions per CG cycle.

FIG. 5A shows an example of a CG configuration with multi-PUSCH occasions per CG cycle with different offsets per PUSCH occasion in the CG cycle.

FIG. 5B shows an example of a CG configuration with multi-PUSCH occasions per CG cycle with periodic PUSCH occasions in the CG cycle

FIG. 6 shows an example of PUSCH occasions grouping across multiple CG configurations.

FIG. 7 shows an example of PUSCH occasions grouping across multiple CG configurations and when a PUSCH occasion in the group is cancelled the remaining PUSCH occasions in the group are also cancelled.

FIG. 8 shows an example of a CG configuration with multi-PUSCH occasions per CG cycle with a CG-UCI bit-field (or MAC CE) to indicate the PUSCH occasions to be maintained and the CG PUSCH occasions to be cancelled.

FIG. 9 shows an example of a CG configuration with multi-PUSCH occasions per CG cycle with a CG-UCI bit-field (or MAC CE) to indicate the PUSCH occasions to be maintained and the CG PUSCH occasions to be cancelled without the first occasion as it mayn't be cancelled.

FIG. 10 shows an example of a CG configuration with multi-PUSCH occasions per CG cycle with a CG-UCI bit-field (or MAC CE) to indicate the remaining PUSCH occasions to be maintained and the CG PUSCH occasions to be cancelled. A padding may be used to keep a constant/fixed bit-field size.

FIG. 11 shows an example of a CG configuration with multi-PUSCH occasions per CG cycle with the cancellation indication that applies to all the remaining PUSCH occasions in the CG period.

FIG. 12 shows an example of a CG configuration with multi-PUSCH occasions per CG cycle with the cancellation indication that applies starting at a specific indicated slot index.

FIG. 13 shows an example of a CG configuration with multi-PUSCH occasions per CG cycle with the cancellation indication that applies starting at a specific indicated PUSCH occasion index.

FIG. 14 shows an example of a CG configuration with multi-PUSCH occasions per CG cycle with the cancellation indication signalling the index of the first PUSCH occasion to be cancelled.

FIG. 15 shows an example of a CG configuration with multi-PUSCH occasions per CG cycle with the cancellation indication signalling the index of the first PUSCH occasion to be cancelled with relative to the PUSCH occasion on which the indication is transmitted from the UE to the base station.

FIG. 16 shows an example of a CG configuration with multi-PUSCH occasions per CG cycle with the cancellation indication signalling the index of the last PUSCH occasion to be used.

FIG. 17 shows an example of a CG configuration with multi-PUSCH occasions per CG cycle with the indication signalling the need for extra resources or extra CG PUSCH occasions.

FIG. 18 shows an example of a CG configuration with multi-PUSCH occasions per CG cycle with a configuration of a maximum and a minimum number of CG occasions to be used, where the UE may add more PUSCH occasions or cancel PUSCH occasions within a specific interval.

FIG. 19 shows an example of a CG configuration with multi-PUSCH occasions per CG cycle, and with the base station switching to dynamic grant (DG) scheduling following an indication from the UE.

FIG. 20 shows an example of an UL CG transmission where the base station fails to decode the transmission and the base station is sending a retransmission scheduling but in the meantime the UE decides to discard the data.

FIG. 21 shows an example of an UL CG transmission where the base station fails to decode the transmission and the base station is sending a retransmission scheduling but in the meantime the UE decides to discard the data. The UE is using the scheduled resources to send discard indication with dummy padding.

FIG. 22 shows an example of an UL CG transmission where the base station fails to decode the transmission and the base station is sending a retransmission scheduling but in the meantime the UE decides to discard the data. The UE is using the scheduled resources to send a new UL PUSCH transmission.

FIG. 23 is a flowchart showing the adaptation of Multi-PUSCH CG configuration with cancellation or request of resources indication.

FIG. 24 is a flow diagram depicting a method for requesting modification to PUSCH occasions by a UE device.

FIG. 25 is a flow diagram depicting a method by a network entity.

Like numerals indicate like elements.

### DETAILED DESCRIPTION

The present disclosure provides enhanced UL scheduling mechanisms for real time media services, e.g., eXtended Reality services (XR) and cloud gamming services, requiring high data rate and low latency. The disclosure proposes enhancement to configured grant (CG) scheduling mechanisms to better support UL XR traffic.

XR is a very demanding service. XR has high data rates requirements and very low latency and high reliability requirements. These stringent requirements although needed to guarantee good user quality of experience (QoE), they however limit the system capacity which makes the service not very attractive for deployment. Scheduling Enhancements are needed to allow for larger number of UEs to consume the service simultaneously. Scheduling enhancements may include new scheduling techniques but also enhancement to the existing techniques. Enhancements, to be efficient, need to take into consideration the specificities of the XR traffic (periodicities, packets sizes, jitter, . . . ).

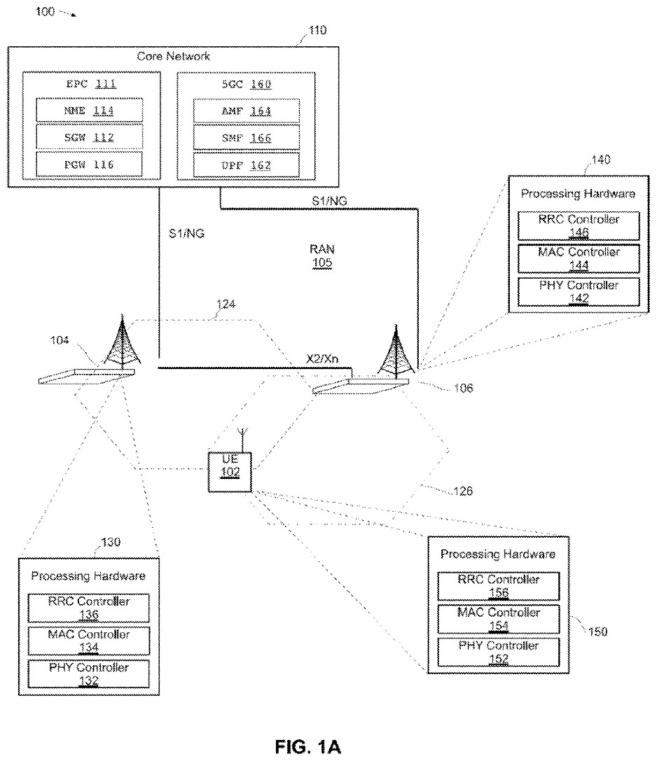

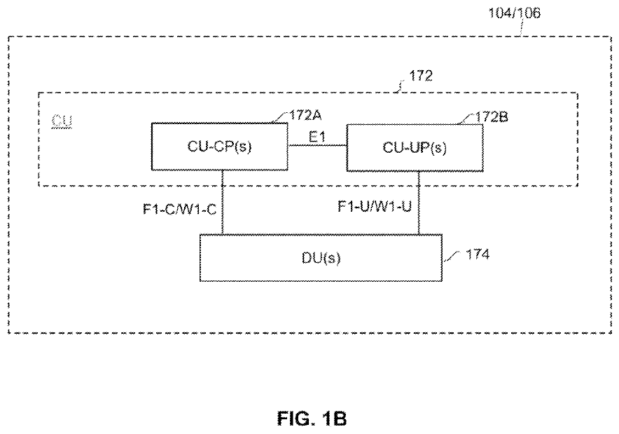

The XR traffic is a quasi-periodic traffic with the period equal to the inverse of the XR frame rate. Hence, if the frame rate is 60 frames per second (fps), the periodicity is 16.67 milliseconds (ms). The XR traffic suffers from jitter due to the delay variations at the codec to encode the video frames. The jitter was statistically modeled in 3GPP as truncated Gaussian distribution with 2 ms standard deviation and +/−4 ms range. The XR packet sizes are also very large and variable due to the variability in the video frame content and were also statistically modeled in 3GPP as truncated Gaussian distribution. FIG. 1 shows an example of the XR traffic shape. The present disclosure therefore provides new configured grant enhancement to the existing scheduling mechanisms to enable the support of the UL XR service on 5G with good system capacity. In some examples, the present disclosure also provides enhancement to buffer status reporting (BSR) mechanisms to improve the UL XR reporting and further sharing UE assistance information for better UL scheduling.

FIG. 1A depicts an example wireless communication system 100 in which communication devices may implement these techniques. The wireless communication system 100 includes a UE 102, a base station (BS) 104, a base station 106 and a core network (CN) 110. The UE 102 initially connects to the base station 104. In some scenarios, the base station 104 may perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 may be implemented as a master eNB (MeNB) or a master gNB (MgNB), and the base station 106 may be implemented as a secondary gNB (SgNB). The UE 102 may communicate with the base station 104 and the base station 106 via the same RAT such as EUTRA or NR, or different RATs. When the base station 104 is an MeNB and the base station 106 is a SgNB, the UE 102 may be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 may be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 may operate in DC with the base station 104 and an additional base station (not shown in FIG. 1A) for example prior to the handover. The UE 102 may continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 may be an evolved packet core (EPC) 111 or a fifth-generation core (5GC) 160, both of which are depicted in FIG. 1A. The base station 104 may be an eNB supporting an Si interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 may support an X2 or Xn interface. Among other components, the EPC 111 may include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage Protocol Data Unit (PDU) sessions.

As illustrated in FIG. 1A, the base station 104 supports cell 124, and the base station 106 supports a cell 126. The cells 124 and 126 may partially overlap, so that the UE 102 may communicate in DC with the base station 104 and the base station 106, where one of the base stations 104 and 106 is an MN and the other is an SN. The base station 104 and base station 106 may support additional cell(s) (not shown in FIG. 1A). The base station 104 may operate the cells 124 and/or additional cell(s) via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.

In general, the wireless communication network 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure also may apply to other suitable radio access and/or core network technologies such as sixth generation (6G) radio access and/or 6G core network or 5G NR-6G DC.

With continued reference to FIG. 1A, the base station 104 is equipped with processing hardware 130 that may include one or more general-purpose processors (e.g., CPUs) and a non-transitory computer-readable memory storing instructions that the one or more general-purpose processors execute. Additionally, or alternatively, the processing hardware 130 may include special-purpose processing units. The processing hardware 130 may include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 may further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 may include processing hardware 140 that is similar to processing hardware 130. In particular, the components 142, 144, and 146 may be similar to the components 132, 134, and 136, respectively.

The UE 102 is equipped with processing hardware 150 that may include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random access procedure, managing UL timing advance for the one or more user devices, and communicating UL/DL MAC PDUs with the base station 104 or 106. The processing hardware 150 may further include an RRC controller 156 to implement procedures and messaging at the RRC sublayer of the protocol communication stack.

In operation, the UE 102 in DC may use a radio bearer (e.g., a DRB or an SRB) that at different times terminates at the MN 104 or the SN 106. The UE 102 may apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation may include a centralized unit (CU) 172 and one or more distributed units (DUs) 174. The CU 172 includes CU control planes (CU-CP(s)) 172A and CU user planes (CU-UP(s) 172B. The CU 172 is equipped with processing hardware that may include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an SN RRC controller 142 configured to manage or control one or more RRC configurations and/or RRC procedures when the base station 106 operates as an SN. The DU 174 is also equipped with processing hardware that may include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106 operates as an MN or an SN. The process hardware may include further a physical layer controller configured to manage or control one or more physical layer operations or procedures.

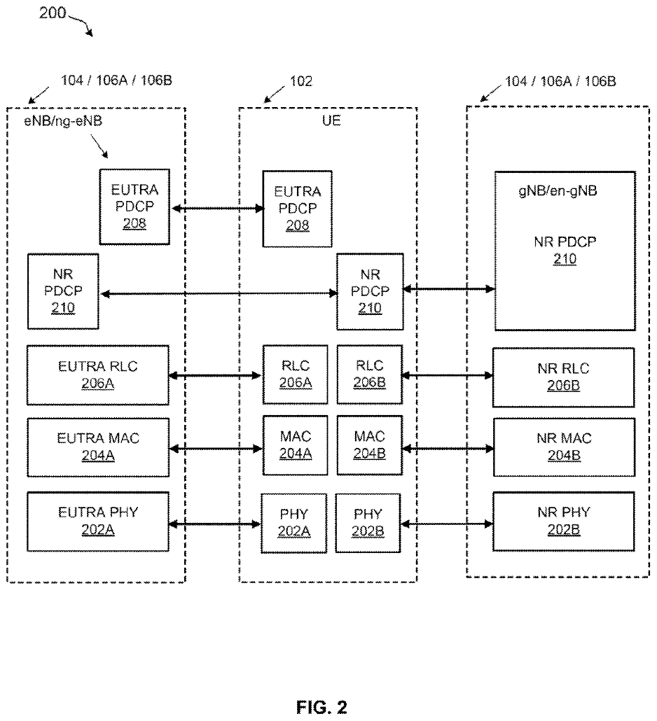

Next, FIG. 2 illustrates in a simplified manner a radio protocol stack 200 according to which the UE 102 may communicate with an eNB/ng-eNB or a gNB. Each of the base stations 104 or 106 may be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 may support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that may be referred to as service data units (SDUs), and output packets (e.g., to the RLC layer 206A or 206B) that may be referred to as protocol data units (PDUs). Except where the difference between SDUs and PDUs is relevant, this disclosure for simplicity refers to both SDUs and PDUs as “packets.”

On a control plane (CP, e.g., the CU-CP(s) 172A), the EUTRA PDCP sublayer 208 and the NR PDCP sublayer 210 provide SRBs to exchange Radio Resource Control (RRC) messages, for example. On a user plane (UP, e.g., the CU-UP(s) 172B), the EUTRA PDCP sublayer 208 and the NR PDCP sublayer 210 provide DRBs to support data exchange.

When the UE 102 operates in EUTRA/NR DC (EN-DC), with the base station 104 operating as a MeNB and the base station 106 operating as a SgNB, the network may provide the UE 102 with an MN-terminated bearer that uses EUTRA PDCP 208 or MN-terminated bearer that uses NR PDCP 210. The network in various scenarios also may provide the UE 102 with an SN-terminated bearer, which use only NR PDCP 210. The MN-terminated bearer may be an MCG bearer or a split bearer. The SN-terminated bearer may be a SCG bearer or a split bearer. The MN-terminated bearer may be an SRB (e.g., SRB1 or SRB2) or a DRB. The SN-terminated bearer may an SRB (e.g., SRB) or a DRB.

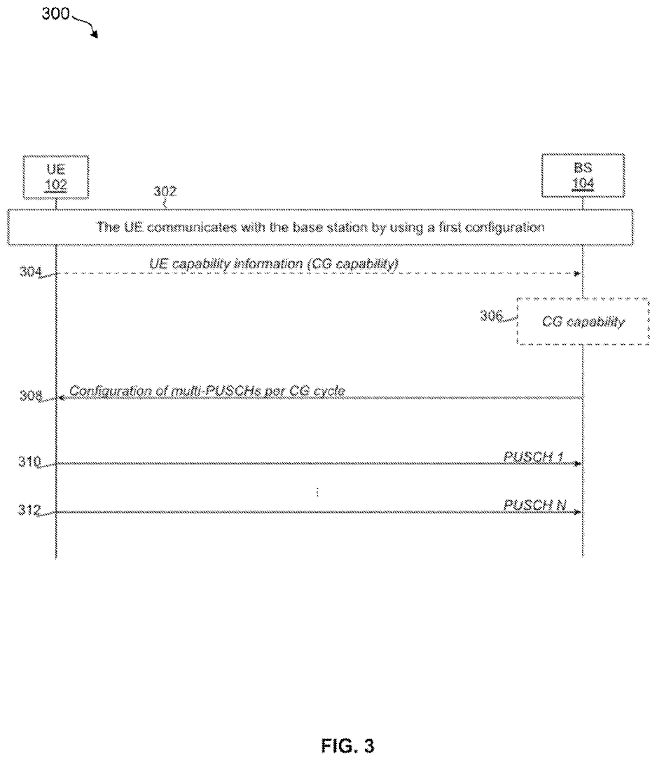

Referring first to FIG. 3, in a scenario 300, the UE 102 initially communicates 302 with the base station 104 using a first configuration. In some implementations, the UE 102 in carrier aggregation (CA) communicates with the base station 104 on the cell 124 and other cell(s) using the first configuration. In other implementations, the UE 102 communicates with the base station 104 on the cell 124 only. In some implementations, the UE 102 communicates with the base station 104 on the cell 124 and/or other cell(s) via one or multiple TRPs. In some implementations, the cell 124 may be a PCell or a PSCell. In such cases, the other cell(s) include SCell(s) and/or additional cell(s) associated with the PCell or a SCell. In other implementations, the cell 124 may be a SCell, and one of the other cell(s) is a PCell. In such cases, the rest includes SCell(s) and/or additional cell(s) associated with the PCell or a SCell.

In the event 302, the UE 102 may transmit UL PDUs and/or UL control signals to the base station 104 on the cell 124 and/or other cell(s) via one or multiple TRPs. In some implementations, the UE 102 communicates UL PDUs and/or DL PDUs with the base station 104 via radio bearers which may include SRBs and/or DRB(s). The base station 104 may configure the radio bearers to the UE 102. In some implementations, UL control signals include UL control information, channel state information, hybrid automatic repeat request (HARQ) acknowledgements (ACKs), HARQ negative ACKs, scheduling request(s) and/or sounding reference signal(s). Similarly, the UE 102 may receive DL PDUs and/or DL control signals from the base station 104 on the cell 124 and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). The base station 104 may transmit the DCIs on physical downlink control channel(s) (PDCCH(s)) monitored by the UE 102, on the cell 124 and/or other cell(s) via one or multiple TRPs.

In some implementations, the first configuration includes physical layer configuration parameters, MAC configuration parameters, RLC configuration parameters, PDCP configuration parameters, measurement configuration parameters, and/or radio bearer configuration parameters. In some implementations, the first configuration includes a CellGroupConfig IE defined in 3GPP specification 38.331 or configuration parameters in the CellGroupConfig IE. In some implementations, the first configuration includes a CSI-MeasConfig IE, a MeasConfig IE and/or a RadioBearerConfig IE defined in 3GPP specification 38.331 or includes configuration parameters in the CSI-MeasConfig IE, MeasConfig IE and/or RadioBearerConfrg IE. In some implementations, the UE 102 receives these configuration parameters from the base station 104. In other implementations, the UE 102 receives a portion of these configuration parameters from a base station other than the base station 104 and the remaining portion of these configuration parameters from the base station 104.

While the UE 102 communicates with the base station 104, the UE 102 may transmit 304 a UE capability information (e.g., UECapabilityInformation message) including configured grant (CG) capability/capabilities to the base station 104. To simplify the following description, “capabilities” is used to represent “capability/capabilities”. The CG capabilities indicates support of multiple physical uplink shared channels (PUSCHs) per CG cycle. In some implementations, the UE 102 includes other capabilities in the UE capability information. In some implementations, the UE 102 receives a UE capability enquiry message (e.g., UECapabilityEnquiry message) from the base station 104. In response, the UE 102 transmits 304 the UE capability information to the base station 104. In some implementations, the UE 102 generates a container information element (IE) including the CSI report capabilities and other capabilities (i.e., capabilities other than the CSI report capabilities) and includes the container in the UE capability information. In examples, the container IE is a UE-NR-Capability IE or a UE-6G-Capability IE. Alternatively, the base station 104 receives 306 the CG capabilities or container IE from another base station (e.g., the baes station 106) or a core network node (e.g., AMF 164). After receiving the CG capabilities, the base station 104 transmit 308 control signal configuring multi-PUSCH occasions per CG cycle to the UE 102. In some implementations, the base station 104 configures the multi-PUSCH occasions per CG cycle to the UE 102 to accommodate the UL XR traffic (i.e., XR data packets) and address the jitter and the variable packet sizes.

In some implementations, the control signal includes a RRC message. In one implementation, the RRC includes a CG configuration configuring multi-PUSCH occasions per CG cycle. In some implementations, the CG configuration includes at least one of a frequency hopping configuration, a demodulation reference signal (DMRS) configuration, a modulation and coding scheme (MCS) table configuration, a uplink control information (UCI) on PUSCH configuration, a resource block group configuration (RBG), a configuration configuring number of HARQ processes configuration, a periodicity configuration configuring a periodicity of a CG (i.e., CG cycle), a time domain offset configuration, a time domain allocation configuration, a frequency domain allocation configuration, an antenna port configuration, a DMRS sequence initialization configuration, a precoding and number of layers configuration, a sounding reference signal (SRS) resource indicator, a MCS and transport block size (TBS) configuration, and a frequency hopping offset configuration. In some implementations, the base station 104 includes a configuration of occasions (e.g., N occasions) per CG cycle in the CG configuration. N is larger than 1.

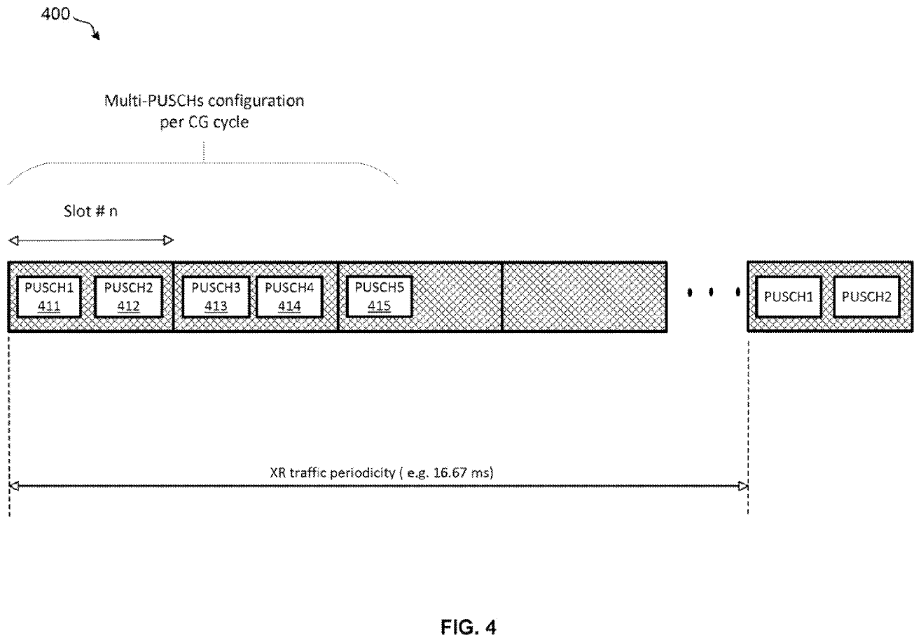

In some implementations, the base station 104 may transmit to the UE 102 downlink control information (DCI) to activate the CG configuration, after transmitting 308 the RRC message to the UE 102. In some implementations, the DCI includes UL resource assignment(s) (e.g., time domain resource assignment and/or frequency domain resource assignment). In some implementations, the DCI signals the number of PUSCH occasions N per CG cycle. The DCI may also signal information for each PUSCH occasion (e.g., start offset, MCS, time domain resource assignment and/or frequency domain resource assignment, . . . ). In response to the DCI, the UE 102 activates the CG configuration. In response to the activation or receiving the DCI, the UE 102 transmits 310 PUSCH transmissions 1, . . . , N (i.e., PUSCHs 1, . . . , N) per CG cycle on the occasions in accordance with the UL resource assignment(s) and configuration(s) in the CG configuration. In other implementations, the UE 102 activates the CG configuration in response to receiving the CG configuration. In response to the activation, the UE 102 transmits 310 PUSCH transmissions 1, . . . , N (i.e., PUSCHs 1, . . . , N) per CG cycle in accordance with the CG configuration. For example, the UE 102 transmits 310 PUSCH transmissions 1, . . . , N (i.e., PUSCHs 1, . . . , N) per CG cycle on the occasions in accordance with the time domain allocation configuration, frequency domain allocation configuration and/or configuration(s) in the CG configuration. Each of the PUSCH transmissions 1, . . . , N may include XR data packets and/or non-XR data packets. In some implementations, the UE 102 may determine XR data packets have higher priority than non-XR data packets. In response to the determination, the UE 102 includes XR data packets first in the PUSCH transmissions. If there is remaining space in some or all of the PUSCH transmissions, the UE 102 includes non-XR data packets in the some or all of the PUSCH transmissions. In some implementations, the base station 104 may transmit to the UE 102 a restriction configuration configuring the UE 102 not to use the CG configuration to transmit non-XR data packets. In accordance with the restriction configuration, the UE 102 does not include non-XR data packets in the PUSCH transmissions. In cases where the UE 102 does not receive the restriction configuration, the UE 102 may include XR data packets and/or non-XR data packets in the PUSCH transmissions. Next, several example scenarios that involve several components of FIG. 1A and relate to transmitting data with a CG configuration are discussed. Generally speaking, events in FIGS. 4-19 that are the same are labeled with the same reference numbers.

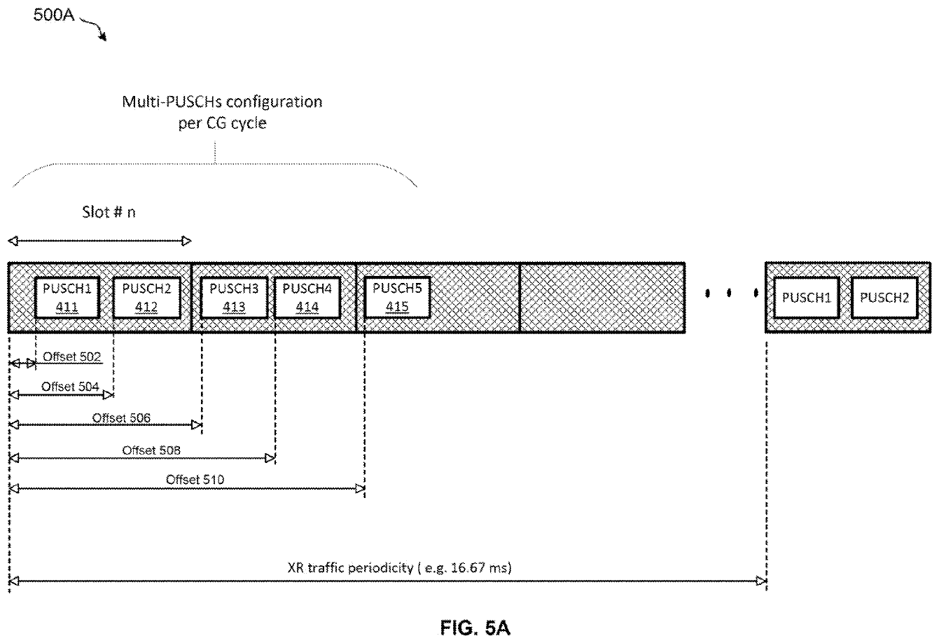

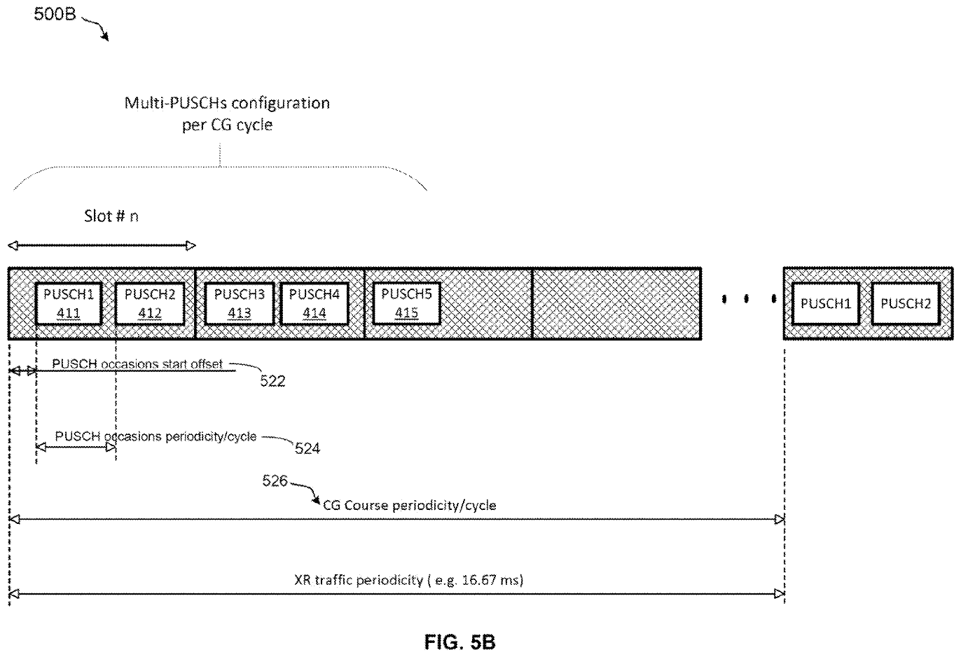

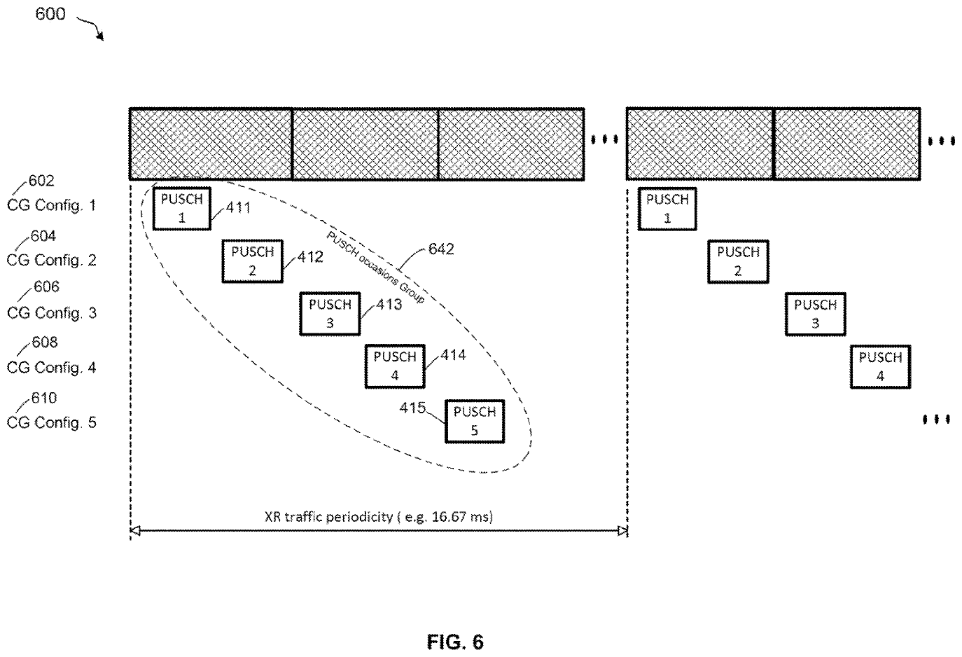

Referring first to FIG. 4, in a scenario 400, the UE 102 is configured with 5 multi-PUSCH occasions per CG cycle (i.e., the case with N=5 in FIG. 3). In the scenario 400, the UE 102 transmits 411, 412, 413, 414 and 415, 5 PUSCH transmissions: 1, . . . , 5 on 5 CG PUSCH occasions configured per CG cycle/period, respectively. In some implementations, the base station 104 may set the periodicity of the CG cycle to a periodicity of XR traffic (e.g., 16.67 ms). For the CG configuration (type 1 and/or type 2), there are the following variants for the RRC CG configuration as described in FIGS. 5A, 5B and 6.

Referring next to FIG. 5A, in a scenario 500A, the CG configuration includes a time offset (e.g., in unit of OFDM symbols, slot, subframe, or frame) to specify a time location for each PUSCH occasion in the CG cycle/period as shown. In some implementations, the CG configuration is a ConfiguredGrantConfig defined in TS 38.331, and an offset configuration is added in the ConfiguredGrantConfig to signal the time offset for each PUSCH occasion. For example, offset1 502 is configured for the 1^{st} PUSCH occasion 411, offset2 504 is configured for the 2^{nd} PUSCH occasion 412, offset3 506 is configured for the 3^{rd} PUSCH occasion 413, offset4 508 is configured for the 4^{th} PUSCH occasion 414, and offset5 510 is configured for the 5^{th} PUSCH occasion 415.

Referring next to FIG. 5B, the CG configuration includes coarse periodicity 526 and fine periodicities 524. The coarse periodicity 526 is for the CG cycle/period and the fine periodicity 524 is for the periodicity of the PUSCH occasions within the CG cycle/period. Similarly, the CG configuration may include coarse and fine offsets. The coarse offset is for the CG cycle/period and the fine offset 522 is for the PUSCH occasions within the CG cycle/period. The fine offset 522 may be relative with the start of the CG period/cycle or the start of the C-DRX OnDuration. In some implementations, the fine periodicity 524, the fine offset 522 and PUSCH occasions offsets 502, 504, 506, 508, 510 are in unit of OFDM symbols, slot, subframe, or frame. In some implementations, the CG configuration is a ConfrguredGrantConfrg defined in TS 38.331, and ConfiguredGrantConfig includes a fine periodicity 524 to signal the fine PUSCH occasions periodicity 524 and/or the fine offset 522 for the PUSCH occasions.

In the scenarios 500A and 500B, the base station 104 may configure the UE 102 one grant applied to the PUSCH transmissions 411-415. In some implementations, the base station 104 transmits to the UE 102 a DCI, on a PDCCH, configuring the grant applied to the PUSCH transmissions 411-415. In other implementations, the base station 104 includes configuration parameters of the grant in the CG configuration. In some alternative implementations, the base station 104 may configure the UE 102 a grant for each of the PUSCH transmissions 411-415. The grants may include the same or different configuration parameters. In some implementations, the base station 104 transmits to the UE 102 a DCI, on a PDCCH, configuring each of the grants applied to the PUSCH transmissions 411-415 respectively. In other implementations, the base station 104 includes configuration parameters of the grants in the CG configuration. The grant(s) may include one or multiple of: different time and frequency resources (RB allocation), different MCS values, . . . etc.

In another embodiment, the base station 104 may configure the UE 102 with CG PUSCH occasions in one slot and request the UE to assume the same allocations across a specific number of slots. For that, the base station 104 may also configure the UE 102 with the number of slots (e.g., via RRC configuration as part of the ConfiguredGrantConfig). The base station 104 configures the UE 102 with the time and frequency domain allocations of the PUSCH occasions in the first slot and the same allocation is assumed by the UE for the remaining slots. For example, the base station 104 configures the UE 102 with two PUSCH occasions in the first slot and signals the configurations of the two PUSCH occasions (FDRA/TDRA, MCS, . . . ) and also the base station signals a number of slots equal to 3. The UE may interpret that the same allocation of the first slot is repeated for the other two slots.

Referring next to FIG. 6, a scenario 600 in which the base station 104 transmits to the UE 102 multiple CG configurations each configuring a particular PUSCH occasion of the PUSCH occasions 411-415 and transmits to the UE 102 a grouping configuration (e.g., a RRC information element) grouping different PUSCH occasions configured in the multiple CG configurations as an PUSCH occasions group for cancellation. In some implementations, a PUSCH occasions group 642, is a group of PUSCH occasions where each occasion belongs to a CG configuration (e.g., as in FIG. 6, CG configuration (Config) 1 602, CG Config 2 604, CG Config 3 606, CG Config 4 608. CG Config 5 610). In some implementations, the CG configurations include different time offsets (e.g., in symbols, slot, subframe, or frame) specifying different time locations.

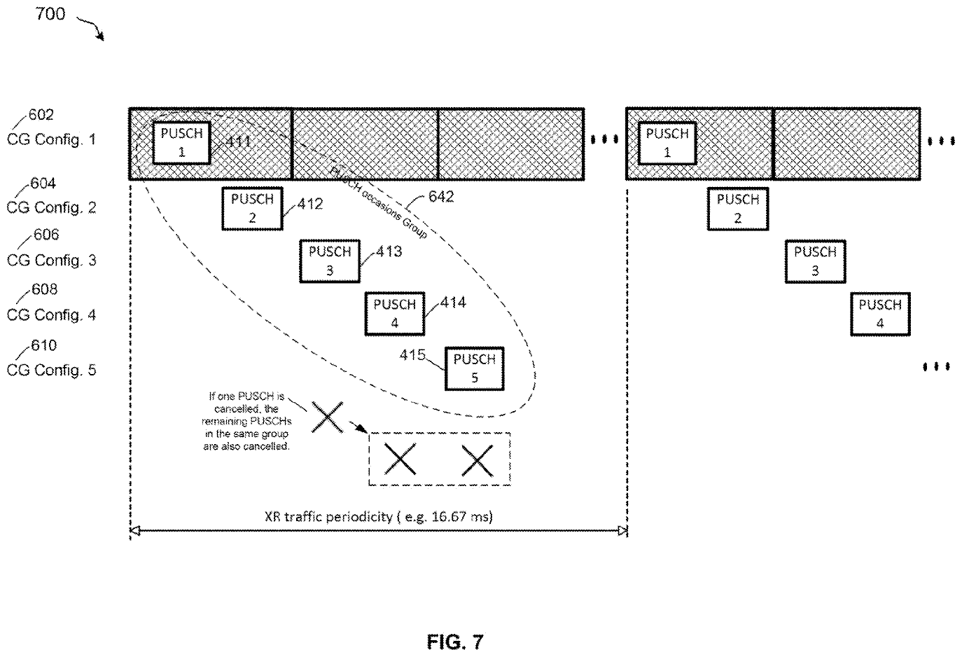

Referring next to FIG. 7, a scenario 700 is similar to the scenario 600. In this scenario, when the UE 102 cancels a PUSCH transmission in a PUSCH occasions group the UE 102 cancels the remaining PUSCH transmissions in the same group. For example, if the UE 102 cancels the PUSCH 3 in FIG. 6, then the UE 102 cancels the PUSCH 4 and PUSCH 5. In one embodiment, if the UE 102 determines to cancel a particular PUSCH occasion or a PUSCH transmission on the PUSCH occasion, the UE 102 may signal an index of the CG configuration to which the PUSCH occasion belongs.

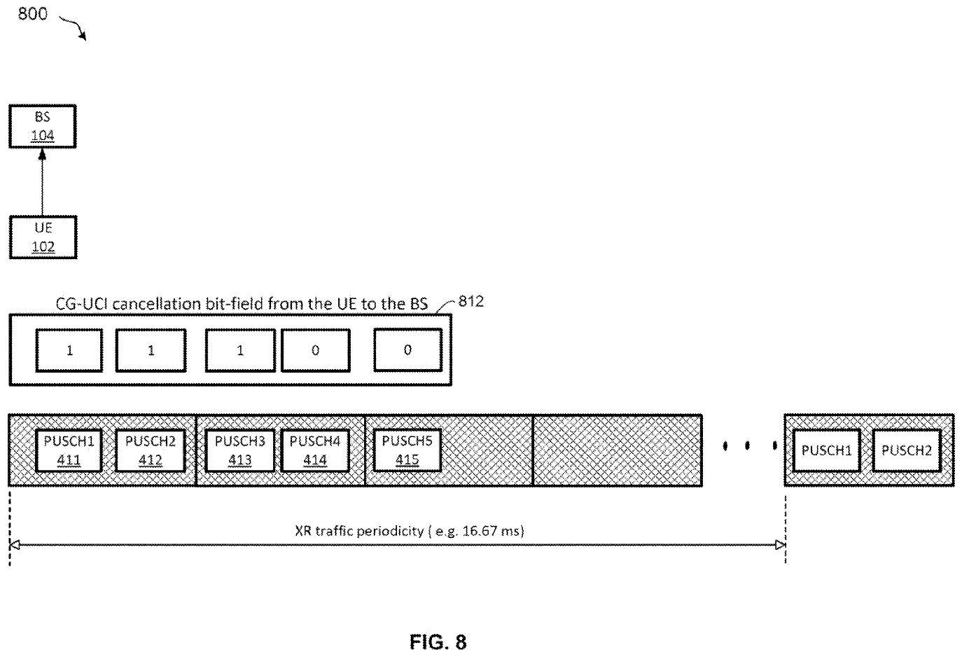

Referring next to FIG. 8, a scenario 800 is similar to the scenario 400. In this scenario, the UE 102 transmits to the base station 104 a cancellation indication indicating the unused CG PUSCH occasions or resources within a CG cycle. The cancellation indication may take place in any CG cycle.

In some implementations, the cancellation indication is configured grant UL Control Information (CG-UCI). In one implementation, the UE 102 transmits the UCI on a PUCCH (PUCCH UCI) in the CG cycle. In another implementation, the UE 102 includes the CG-UCI in a PUSCH transmission on a CG PUSCH occasion in the CG cycle. For example, the UE 102 multiplexes the CG-UCI with the PUSCH transmission. In some implementations, the PUSCH transmission is the first PUSCH transmission on the first CG PUSCH occasion in the CG cycle (e.g., the PUSCH transmission 1). Thus, the UE 102 may inform early the base station 104 of the unused CG PUSCH occasions and the base station may schedule other UEs to transmit PUSCH transmissions on the unused CG PUSCH occasions. In other implementations, the UE 102 includes the CG-UCI in any of the PUSCH transmissions in the CG cycle. In yet other implementations, the base station 104 transmits to the UE 102 a cancellation configuration configuring a specific PUSCH occasion in the CG cycle for the UE 102 transmit the cancellation indication. In such cases, the UE 102 transmits the cancellation indication on the specific PUSCH occasion.

In other implementations, the cancellation indication is a MAC control element (CE). The UE 102 may generate a MAC PDU including the MAC CE and transmits the MAC PDU in a PUSCH transmission to the base station 104.

Because of the cancellation indication, the UE 102 may inform early the base station 104 of the unused CG PUSCH occasions and the base station may schedule other UEs to transmit PUSCH transmissions on the unused CG PUSCH occasions. Therefore, better spectral efficiency is achieved and no UL radio resources on the unused CG PUSCH occasions are wasted.

Referring next to FIG. 8, and in some implementations, the UE 102 may send to the base station 104 CG-UCI or PUCCH UCI which may include a new bit-field or re-use an existing bit-field to indicate the unused PUSCH occasions or resources within the CG cycle. In some implementations, the UE 102 includes the new bit-field in the CG-UCI when the UE 102 receives the high layer parameter cg-UCI-Multiplexing from the base station 104. The new UCI bit-field (CG-UCI or UCI on PUCCH) may include a bitmap[a₁, a₂, . . . , aₖ, . . . , a_{N}], where N is the length of the bitmap and is equal to the number of PUSCH occasions in the CG cycle. aₖ in the bitmap may take a value of 0 or 1 and is the UE uses it to indicate if the occasion is to be cancelled or to be maintained. For example, if 1 is used to indicate a PUSCH occasion is to be maintained and 0 is used to indicate a PUSCH occasion is to be cancelled, then if 5 PUSCH occasions are configured per CG cycle, a bitmap of [1 1 1 0 0] as in 812 indicates to the base station 104 that the first 3 PUSCH occasions are to be maintained and used by the UE and that the last two PUSCH occasions are to be cancelled and not required by the UE as shown in the example of FIG. 8. This solution gives the flexibility to cancel non-contiguous occasions. For example, the UE 102 may signal to the base station 104 the following bitmap [1 1 0 1 0] cancelling two non-contiguous PUSCH occasions. The base station 104 may interpret the bitmap regardless of the position of the CG PUSCH occasion which carries the CG-UCI or/and regardless of the position of the PUCCH carrying the UCI.

In another embodiment, and referring to FIG. 8, the past bits may be fixed to 0 or 1. For example, if the bitmap [a₁, a₂, . . . , aₖ, . . . , a_{N}] is to be transmitted on the UCI to indicate the unused CG PUSCH occasions, and if the UCI is transmitted on CG PUSCH occasion k then the bits a₁ to aₖ (or to aₖ₋₁) may be fixed to 0 or fixed to 1, as they are pointing to CG PUSCH occasions in the past and they are no longer useful.

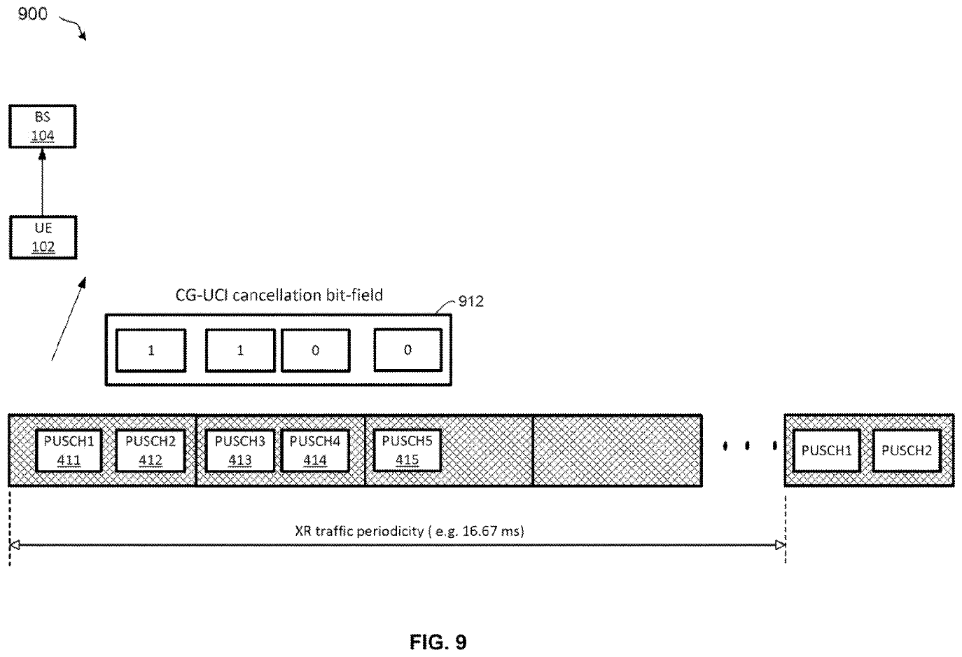

Referring next to the scenario 900 of FIG. 9, and in some implementations, T=the new UCI bit-field (CG-UCI or UCI on PUCCH, such as the example CG-UCI cancellation bit-field 912 shown in FIG. 9) may include a bitmap[a₂, . . . , aₖ, . . . , a_{N}], where N−1 is the length of the bitmap and N is equal to the number of the configured PUSCH occasions per CG cycle. Since the base station 104 cannot cancel the first PUSCH occasion, the UE doesn't need to include it in the bitmap.

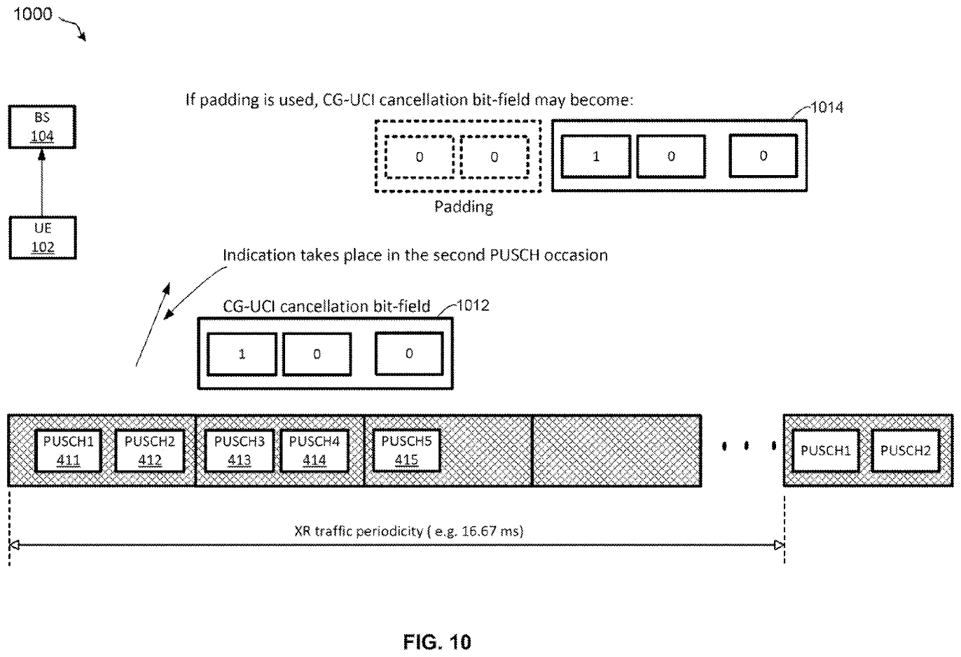

Referring next to the scenario 1000 of FIG. 10, and since the signalling of the indication about the past CG PUSCH occasions in the CG cycle (that the UE 102 has already consumed) don't matter anymore and there is no need to indicate them in the bitmap anymore as in 1012, the base station 104 needs only an indication about the future PUSCH occasions in the CG cycle. Hence, if the indication is sent in the PUSCH occasion k (on a CG-UCI, PUCCH UCI or via MAC-CE) and if the UE 102 is using a bitmap for the indication, the bitmap may be [aₖ₊₁, . . . , a_{N}] as shown in FIG. 10. The concern with this approach is that the bitmap size may change according to the position of the CG PUSCH occasion on which the cancellation signalling takes place. In one embodiment, the UE 102 may use padding to get a constant size bitmap (but then overhead is not better than the previous solution) as shown in FIG. 10 as given in 1014. Hence, this signalling may take place on any PUSCH occasion or any PUCCH and it may indicate only the status of the future PUSCH occasions in the CG cycle.

In another embodiment and referring to FIG. 10, since the size of the bitmap to be sent on the UCI indicating the unused CG occasions may change depending on the position of the CG PUSCH carrying the UCI, a table may be used to keep the number of bits (to be transmitted on the UCI) constant. The table may be defined/specified or may be configured by the base station 104 to the UE 102. For example, if 5 CG occasions are to be indicated by the UCI, the Table 1 below may be configured to the UE 102 by the base station 104:

TABLE 1
Example bitmap and UCI bits

| Bitmap | UCI bits |
|---|---|
| 0000 | 000 |
| 0001 | 001 |
| 0011 | 010 |
| 000 | 100 |
| 001 | 110 |
| 011 | 011 |
| 00 | 101 |
| 01 | 111 |

In the configuration of the table, the base station may select some of the possible combinations and configure them in the table to have a fixed number of bits in the UCI to be carried on the CG PUSCH. In the example above, the total number of possible bitmaps is 2\hat{ }4+2\hat{ }3+2\hat{ }2+2=29. To cover all possible combinations, the UCI bits should be equal to 5 and the table length should be 32 rows. The base station 104 may select some of the combinations to construct the table and configure the table to the UE 102 based on these combinations like in the table of the example above where the length of the table is 8 rows instead of 32 rows. This reduces the number of bits required for the signalling the UCI to 3 bits instead of 5 bits required initially to cover all possible combinations. The table may have other sizes like 16 rows (4 bits in the UCI) or 4 rows (2 bits in the UCI). Hence, assuming M CG PUSCH occasions are to be indicated as unused or not by the bitmap, then the size of the table may be N≤2^{M}. The number of rows in the table may be RRC configured to the UE 102 via an explicit signalled parameter. In another example, the length of the bitmap may be RRC configured to the UE 102 via an explicit signalled parameter. The maximum possible size of the table may be specified/pre-defined. The maximum possible size of the bitmap may be specified/pre-defined.

In some embodiments, the UE may transmit the CG-UCI bits on a CG PUSCH. The CG-UCI bits may have a sequence of a₀, a₁, a₂, a₃, . . . , a_{A-1}, determined as follows:
set

$${a}_{i} = {\tilde{o}}_{i}^{CG - UCI}$$

for i=0, 1, . . . , O^{CG-UCI}−1 and A=O^{CG-UCI}, where the CG-UCI bit sequence

$${\tilde{o}}_{0}^{CG - UCI} , {\tilde{o}}_{1}^{CG - UCI} , … , {\tilde{o}}_{{o}^{CG - UCI} - 1}^{CG - UCI}$$

is given by Table 2 below, mapped in the order from upper part to lower part.

TABLE 2
Mapping order of CG-UCI fields

| Field | Bitwidth |
|---|---|
| HARQ process number | 4 |
| Redundancy version | 2 |
| New data indicator | 1 |
| Channel Occupancy Time (COT) sharing | [log₂C] if both higher layer parameter ul- |
| information | toDL-COT-SharingED-Threshold and higher |
| | layer parameter cg-COT-SharingList are |
| | configured, or if both higher layer parameter |
| | ue-SemiStaticChannelAccessConfig and |
| | higher layer parameter cg-COT-SharingList |
| | are configured, or if higher layer parameter |
| | cg-COT-SharingList is configured in |
| | frequency range 2-2, where C is the number |
| | of combinations configured in cg-COT- |
| | SharingList; |
| | 1 if higher layer parameter ul-toDL-COT- |
| | SharingED-Threshold is not configured, and |
| | if higher layer parameter ue- |
| | SemiStaticChannelAccessConfig is not |
| | configured, and if higher layer parameter cg- |
| | COT-SharingOffset is configured; |
| | 0 otherwise; |
| | If a UE indicates COT sharing other than “no |
| | sharing” in a CG PUSCH within the UE's |
| | initiated COT, the UE should provide |
| | consistent COT sharing information in all the |
| | subsequent CG PUSCHs, if any, occurring |
| | within the same UE's initiated COT such that |
| | the same DL starting point and duration are |
| | maintained. |
| PUSCH cancellation indication | Number of CG-PUSCH occasions configured |
| | in the CG cycle |
| PUSCH request indication | A higher layer parameter max-PUSCH- |
| | occasions-request configured. |

The number of CG PUSCH occasions (to be indicated in one bitmap carried by the UCI indicating the unused CG PUSCH occasions) may be configured by the base station 104 to the UE 102. A new RRC parameter may be defined/specified to signal the number of CG PUSCH occasions (to be indicated as unused or not-unused in the UCI bitmap). In another example, the number of CG PUSCH occasions (to be indicated in one bitmap carried by the UCI indicating the unused CG PUSCH occasions) may be derived by the UE from the size of the bitmap or the number of bits in the UCI. The CG PUSCH occasions may be confined inside one or multiple CG period(s) or one or multiple XR traffic period(s). The base station 104 may configure the UE with the number of CG periods or the number of XR periods that are indicated by the same bitmap. In another example, the number of the CG periods or the number of XR periods indicated by the same bitmap carried in the UCI may be specified/defined. In another example, a bitmap indicating the unused CG PUSCH occasions maps to the CG PUSCH occasions contained inside a single CG period or inside a single XR period.

In another example, the number of bits in the UCI bitmap may be RRC configured or dynamically indicated (e.g., via DCI) by the base station 104 to the UE 102. A set of possible values may be specified/pre-defined for the number of bits in the UCI bitmap and the base station may configure one of these values to the UE. In another example, the base station may send an indication that points to one of these specified/pre-defined values.

The UCI bitmap (indicating the unused CG PUSCH occasions) may be used as a sliding window where the UCI points to a window of CG PUSCH occasions. An offset or/and a length of the window may be defined/specified or configured (e.g., via RRC or dynamically via DCI indication) by the base station 104 to the UE 102. The reference of the offset is the CG PUSCH carrying the UCI and the unit of the offset may be OFDM symbols, slots, number of CG PUSCH occasions, CG periods, XR periods, etc. The unit of the length of the window may be OFDM symbols, slots, number of CG PUSCH occasions, CG periods, XR periodicities, etc. In one embodiment, the sliding window may be constrained to not cross the CG periods boundaries or/and cross the XR periodicity boundaries.

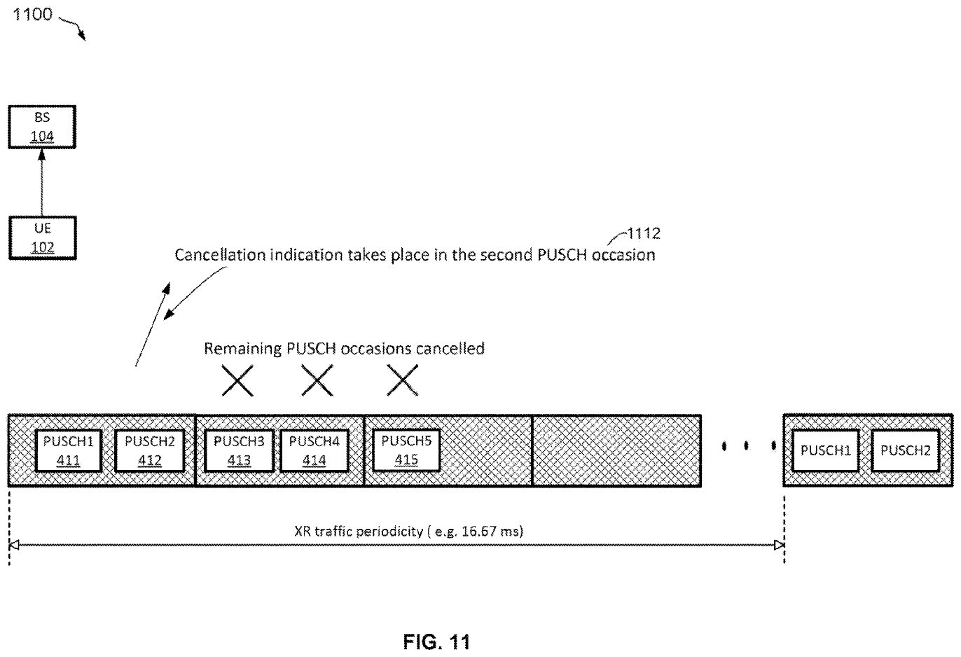

Referring to the scenario 1100 of FIG. 11, and in another embodiment, the UE 102 may signal a cancellation indication 1112 to the base station 104 and the cancellation applies directly to the remaining PUSCH occasions in the CG cycle. The indication may be a single bit to signal a cancellation. Once the base station 104 receives the cancellation, it wouldn't expect any more UL transmissions on the remaining PUSCH occasions from the UE on that specific CG cycle.

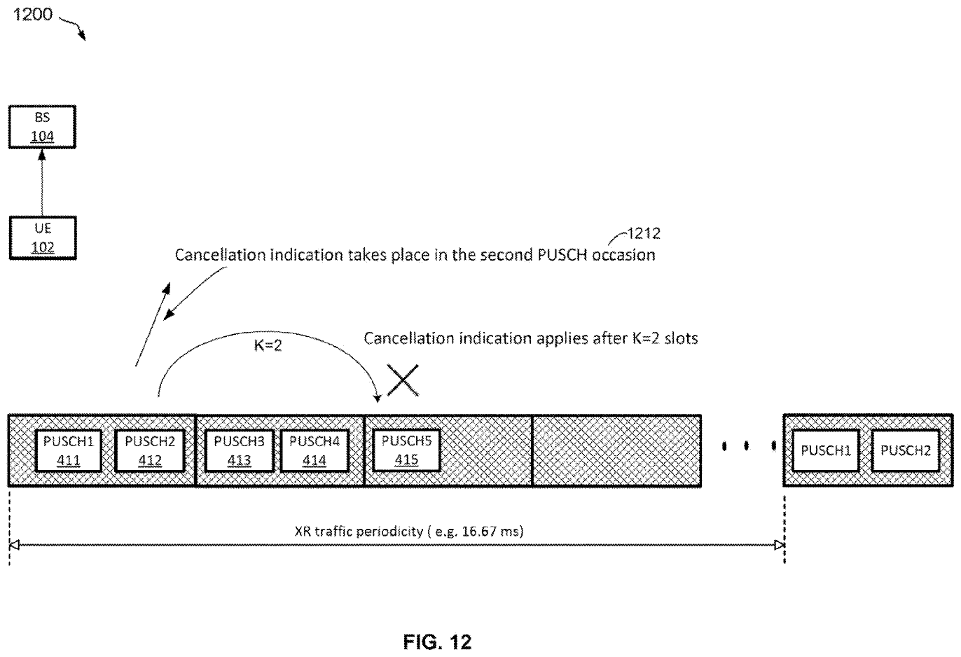

Referring to the scenario 1200 of FIG. 12, the base station 104 may need some time to decode the PUSCH or PUCCH carrying the indication and may continue processing the future PUSCH occasions till it decodes the PUSCH occasion carrying the cancellation. In one embodiment, the UE may signal a cancellation indication which applies from the next UL slot. In another embodiment, the UE 102 may signal a cancellation indication 1212 which applies after K slots as shown in FIG. 12. K may be specified. In another embodiment, 3GPP specifications may specify K per numerology. The advantage of these solutions is the reduced signalling overhead as the UE doesn't need to signal the index of the PUSCH occasion from where the cancellation starts. It offers however less flexibility as the cancellation needs to start at a fixed number of slots from where the slot on which the indication took place.

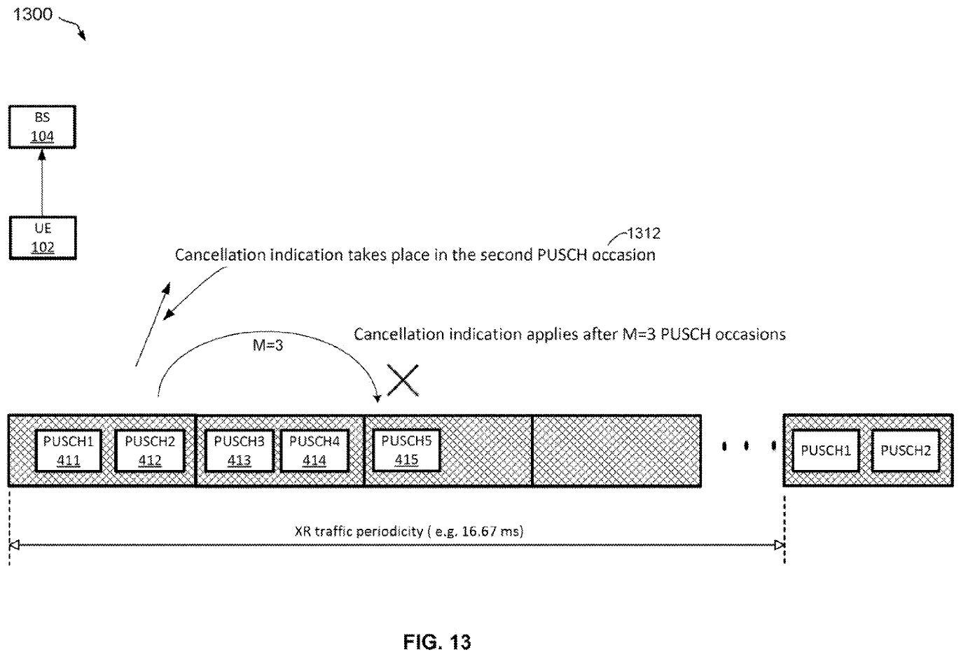

Referring to the scenario 1300 of FIG. 13, and in another embodiment, the UE 102 may signal a cancellation indication 1312 of PUSCH occasions to the base station 104 on a CG-UCI, PUCCH UCI or via MAC-CE. The cancellation applies after M PUSCH occasions. 3GPP specifications may specify the value(s) of M. In a different embodiment, M may be semi-statically configured (e.g., via RRC Information Element). In another embodiment, a set of M values may be defined and the UE may be configured by one of these values. The advantage of these solutions is also the reduced signalling overhead as the UE doesn't need to signal the index of the PUSCH occasion from where the cancellation starts. It offers however less flexibility as the cancellation needs to start at a fixed number of PUSCH occasions from the PUSCH occasion on which the indication took place. This solution allows the base station 104 to have time to process the cancellation indication before the cancellation takes effect. The base station 104 may configure the value of M per UE or per band.

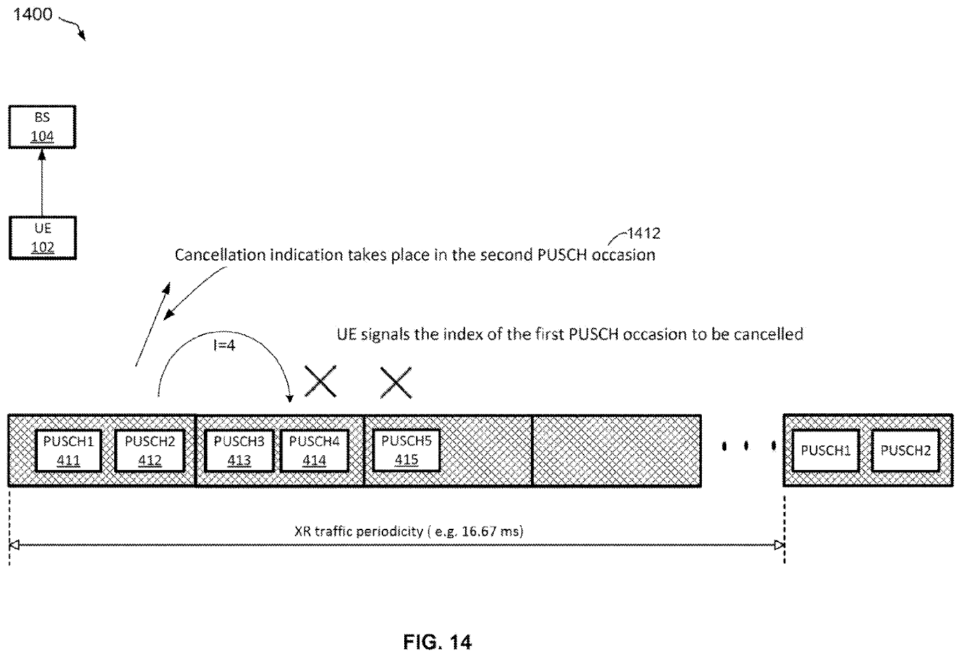

Referring to the scenario 1400 of FIG. 14, and in another embodiment, the UE 102 may signal a cancellation indication 1412 to the base station 104 on a CG-UCI, PUCCH UCI or via MAC-CE and signal the index of CG PUSCH occasion from where the cancellation starts. For example, as shown in FIG. 14, if the base station 104 configures 5 PUSCH occasions per CG cycle and UE needs to cancel the last two occasions, UE may signal in the cancellation indication the index “4” which is the index of the first PUSCH occasion to be cancelled. For that, the signalled index bit-field size would be equal to ┌log₂(N)┐ where N is the number of PUSCH occasions that the base station has configured to the UE 102 per CG cycle. Hence, the total signalling overhead would be:
one bit to signal if the cancellation is on or off
┌log₂(N)┐ to signal the PUSCH occasion index.
   Hence, for example, if the base station 104 has configured to the UE 102 5 PUSCH occasions per CG cycle, the total signalling is 1+┌log₂(5)┐=4 bits.

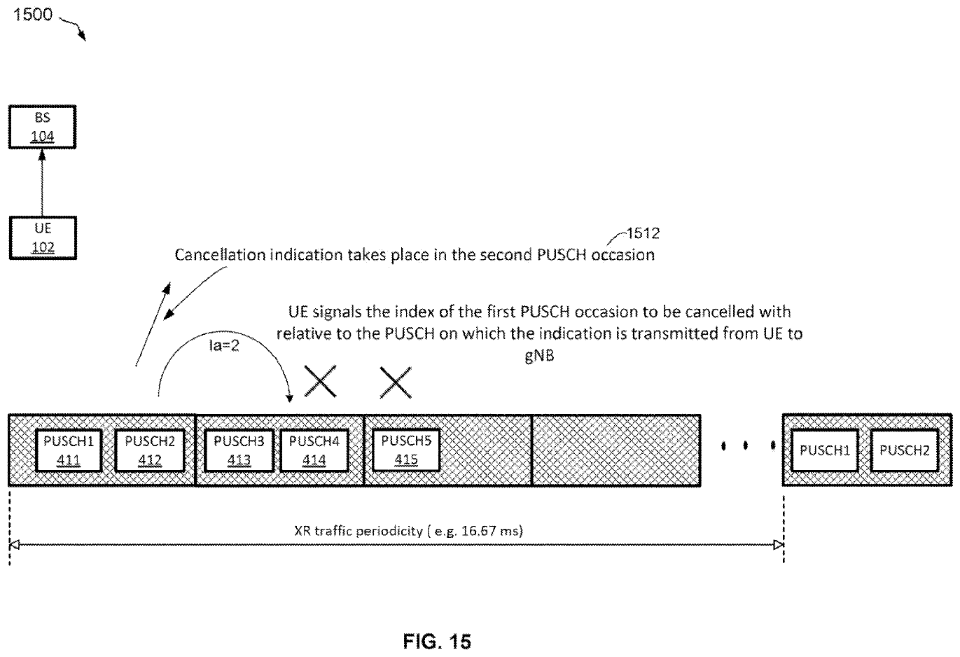

Referring next to FIG. 15, in scenario 1500, the index of the first PUSCH occasion that the UE 102 needs to cancel may be relative to the PUSCH occasion on which the signalling took place as a start reference. For example, if the base station 104 has configured the UE 102 with 5 PUSCH occasions per CG cycle and UE 102 needs to send an indication 1512 to the base station 104 to cancel the last two occasions 414 and 415 and the UE sends the cancellation on occasion 2 on PUSCH 412, UE 102 may signal to the base station 104 in the cancellation indication on PUSCH 412 (on GC-UCI, or MAC-CE) the index “2” which is the index of the first PUSCH occasion 414 that the UE 102 needs to cancel with reference to the occasion on which the cancellation has been sent (PUSCH 412)

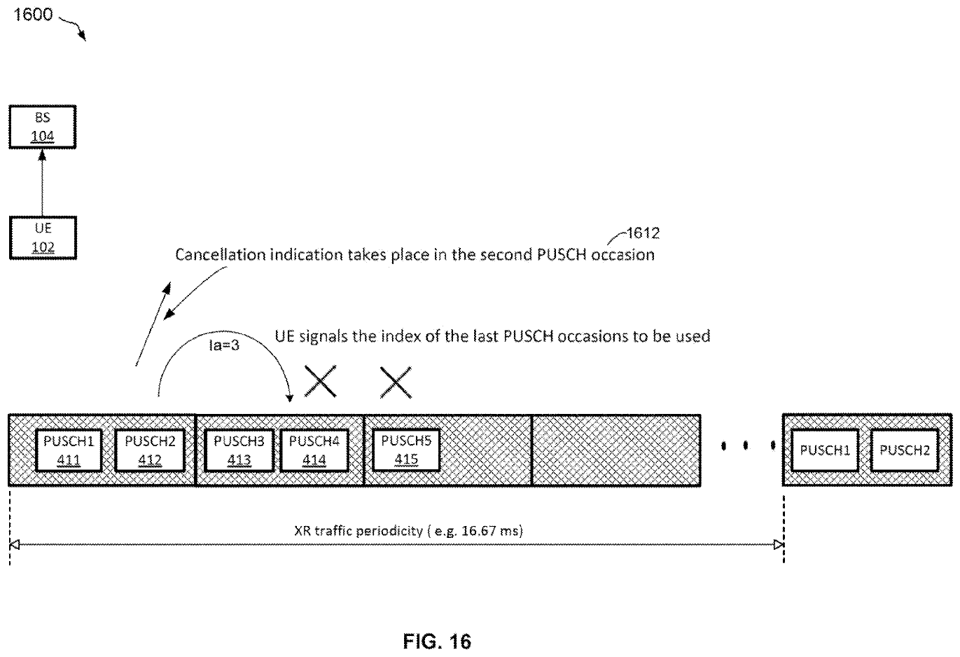

Referring next to FIG. 16, in a scenario 1600, the UE 102 may signal to the base station 104 a cancellation indication 1612 (on GC-UCI, PUCCH UCI, or MAC-CE) and signal the index of the last CG PUSCH occasion that the UE 102 is planning to use, e.g., PUSCH 3 413 in FIG. 16. For example, if the base station 104 has configured the UE 102 with 5 PUSCH occasions per CG cycle as shown in FIG. 16 and UE 102 needs to send an indication to base station 104 to cancel the last two occasions 414, 415, UE may signal in the cancellation indication the index “3” of the last PUSCH occasion that the UE is planning to use as shown in FIG. 16. For that the index bit-field size would be equal to ┌log₂(N)┐ where N is the number of PUSCH occasions configured per CG cycle. Hence, the total signalling overhead would be one bit to signal the cancellation indication and ┌log₂(N)┐ for the occasion index. For example, if 5 PUSCH occasions are configured per CG cycle, the total signalling is 1+┌log₂(5)┐=4 bits.

In some implementations, the UE 102 transmits the cancellation indication if the UE 102 determines that the one or multiple PDUs of a PDU set are to be discarded. E.g., if a PDU of a PDU Set has expired or if the associated PDCP discardTimer has expired. The PDCP discardTimer may be configured based on the PDU Set Delay Budget (PSDB) and may be applicable to determine the discard time of the entire PDU Set.

In some implementations, the video decoder of the UE 102 needs only K PDUs out of the N PDUs in a PDU Set (where N>=K) to recover the video slice/frame thanks to the video FEC encoding. The UE 102 may decide to discard (e.g., at PDCP) the remaining N-K PDUs (which are mainly repair symbols or repetitions) if the K PDUs required by the video codec are successfully transmitted to the base station 104. Hence, the UE 102 may transmit a cancellation indication to cancel the PUSCH occasions or PUSCH resources that are no longer needed by the UE after the discarding of the N-K PDUs.

In some implementations, the UE 102 may transmit to the base station 104 a cancellation indication (e.g., CG-UCI) to cancel PUSCH occasions across CG cycles, e.g., if the UE 102 determines that the UE 102 has no video frames or video slices to transmit in the CG cycles. In such cases, the UE 102 may indicate the CG cycles (e.g., N consecutive CG cycles, where N>1) in the cancellation indication. For example, the UE 102 may include N in the cancellation indication to indicate that the UE 102 cancels PUSCH transmissions/occasions in the N CG cycles.

In some implementations, the UE 102 includes an application processor and a modem, which execute an operating system (e.g., Android, iOS) and modem software, respectively. The UE 102 may execute application(s) on the operating system. In one implementation, the application processor, application(s) or operating system transmits an indication to the modem (software) to indicating no next video frames/slices to be transmitted within a period of time. In such an implementation, the modem may determine CG cycles within the period of time and transmit to the base station 104 a cancellation indication (e.g., CG-UCI) to cancel PUSCH occasions across the CG cycles in response to the indication.

A cancellation indication request may also apply to future CG cycles until amended by the base station or amended by a new UE request. The cancelled PUSCH occasions may also be cancelled in future CG cycles. The UE may resume them if needed. For example, the UE may request to increase the PUSCH occasions in future CG cycles if needed to resume the cancelled occasions.

A cancellation indication request by the UE 102 may need an Acknowledgement from the base station 104 using a scheduling or non-scheduling DCI.

3GPP specifications may specify a limit on the number of PUSCH occasions that may be cancelled, or/and the base station 104 may semi-statically configure the UE 102 with a limit on the number of PUSCH occasions that may be cancelled. This may reduce the UL signalling overhead and simplify the cancellation feature as it may complicate the base station scheduling. For example, the UE 102 may be allowed to cancel the last two PUSCH occasions as a maximum.

The UE 102 may use the new or the existing CG-UCI bit-field as a BSR like mechanism signalling the amount of data to be cancelled or signalling the frequency/time resources that may be cancelled (specific slots, OFDM symbols in time domain and specific RBs in frequency domain).

The UE 102 may have similar mechanism like in DL TDRA tables to indicate the unused resources that may be cancelled. The UE 102 may be configured with an UL TDRA tables or may re-use the DL TDRA to indicate the resources that may be unused (signalling in the CG-UCI, PUCCH UCI, or MAC CE). For frequency resources, the UE 102 may use RIV (Resource Indicator Value) in UL to indicate frequency resources (RB allocation, or RB allocation size) that may be cancelled. The RIV in DL scheduling is used to encode the start and the length of the frequency resources to be used for a particular grant. A similar use may be for the UL cancellation. RIV and/or TDRA indication fields may be defined for the CG-UCI, PUCCH UCI or MAC-CE.

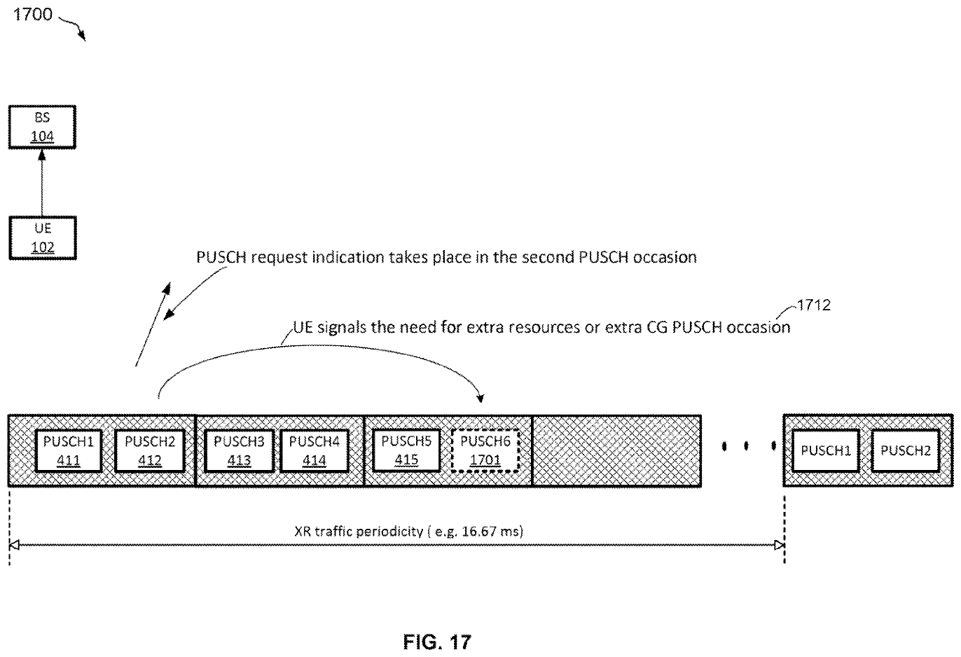

Referring to FIG. 17, in a scenario 1700, the UE 102 may send a request 1712 to base station 104 to request an increase of the PUSCH resources (i.e., CG PUSCH resources) or an additional PUSCH occasion (e.g., the occasion 1701). In some implementations, the request is CG-UCI including anew or an existing CG-UCI bit-field to indicate or request an increase of CG PUSCH resources/occasions in a CG cycle. In other implementations, the request is UCI that the UE transmits on a PUCCH and includes a new or an existing PUCCH-UCI bit-field to indicate or request an increase of CG PUSCH resources/occasions in a CG cycle. In other implementations, the indication or the request is a MAC CE.

In one embodiment, if the base station 104 configures the UE 102 with the RRC parameter cg-UCI-Multiplexing, the UE uses the new CG-UCI bit-field to indicate to the base station 104 a cancellation of the PUSCH resources/occasions. In another embodiment, the base station 104 configures the UE 102 with anew RRC parameter to enable and disable the use of the new CG-UCI bit-field to indicate a cancellation of the PUSCH resources/occasions.

In one embodiment, if the base station 104 configures the UE 102 with the RRC parameter cg-UCI-Multiplexing, the UE uses the new CG-UCI bit-field to indicate to the base station 104 a request for more PUSCH resources/occasions. In another embodiment, the base station 104 configures the UE 102 with a new RRC parameter to enable and disable the use of the new CG-UCI bit-field to indicate the request for more PUSCH resources/occasions.

In some cases, the UCI bit field includes a PUSCH cancellation indication indicating a number of PUSCH occasions configured in each traffic period or a CG cycle. In some cases, the UCI bit field includes a PUSCH request indication indicating a parameter of a maximum number of PUSCH occasions. For example, the parameter is a higher layer parameter that configures a max-PUSCH-occasions-request.

The UE 102 may indicate to the base station 104 the number of extra PUSCH occasions required to transmit the current payload. In another embodiment, the UE 102 may signal the extra-payload that cannot be scheduled in the current resources in bytes (a short BSR-like mechanism). In another embodiment, the UE may indicate the time/frequency domain resources required to schedule the extra-payload that cannot be scheduled with the existing occasions.

In another embodiment, the UE may signal an indication for a need of extra resources. If “No feedback from base station” to the UE then this may be interpreted as an approval to use an extra N PUSCH occasion, e.g., N=1. Otherwise, the base station has the option to switch to DG (Dynamic Grant) to accommodate the extra-payload.

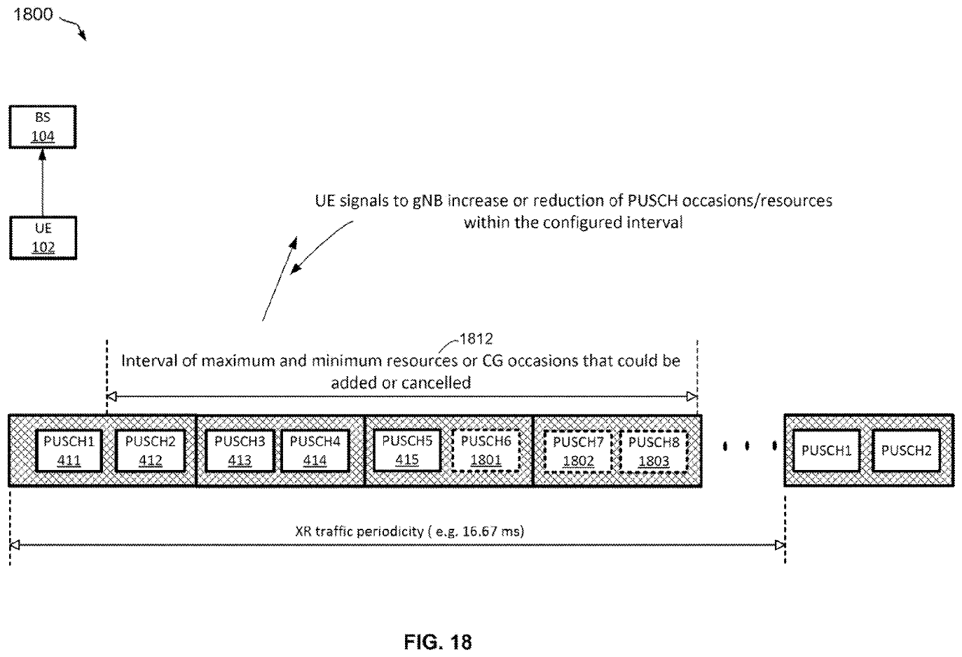

Referring next to FIG. 18, scenario 1800 illustrates an example of a CG configuration with multi-PUSCH occasions per CG cycle with a configuration of a maximum and a minimum number of CG occasions to be used. The UE may add more PUSCH occasions or cancel PUSCH occasions within a specific interval 1812. In the scenario 1800, the base station 104 may configure the UE 102 with a maximum and a minimum number of PUSCH occasions per CG cycle and the UE 102 may have the flexibility to autonomously increase or reduce the number of PUSCH occasions (e.g., the occasions 1801, 1802, and/or 1803)) to be used based on the UL data payload while signalling the increase or the reduction through CG-UCI, PUCCH UCI, or through MAC-CE as explained in FIG. 18. In case of a need for resources larger than the maximum allowed the base station may switch to dynamic scheduling.

The base station 104 may explicitly acknowledge with DL signalling or not the request from the UE to increase or reduce the number of PUSCH occasions or CG resources.

The UE 102 may signal/indicate to the base station 104 the priority of the UL data together with the UL request for more resources. UE 102 may indicate to the base station 104 different requests for different data priorities.

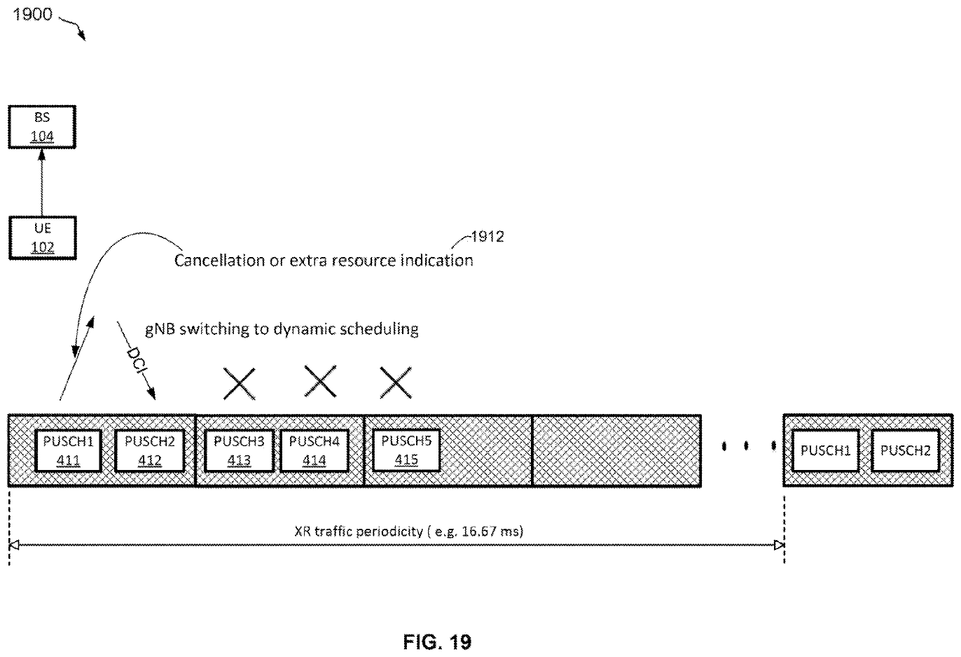

Referring next to FIG. 19, scenario 1900 illustrates an example of a CG configuration with multi-PUSCH occasions per CG cycle, and with the base station switching to DG scheduling following an indication from the UE. The switch to DG cancels the remaining PUSCH CG occasions. In the scenario 1900 as shown, the UE 102 may indicate to the base station 104 a cancellation indication 1912, base station 104 may decide to switch to DG scheduling. Switching to DG may be interpreted by the UE 102 as a cancellation of the remaining CG PUSCH occasions as shown in FIG. 19.

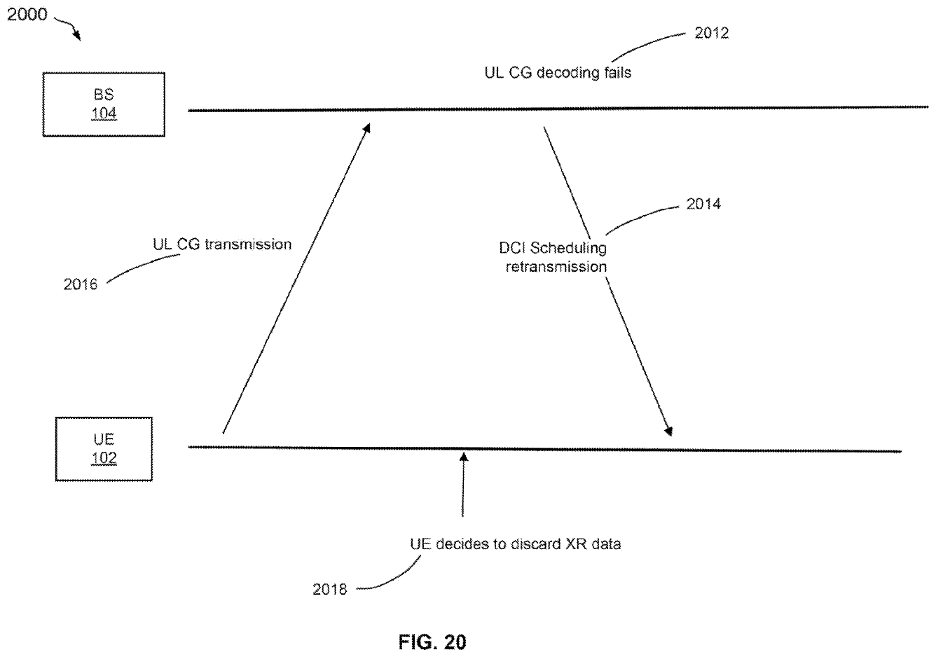

Referring next to FIG. 20, in a scenario 2000, if the UE transmits data to the base station 104 on a CG resource or DG resources 2016 and the base station fails to decode the UL transmission 2012, the base station may schedule a retransmission 2014 but in the meantime the UE may decide to discard the data 2018 as its delay budget has expired or is close to expiry. In one embodiment, the UE may ignore the scheduling DCI that the base station has sent to schedule a retransmission.

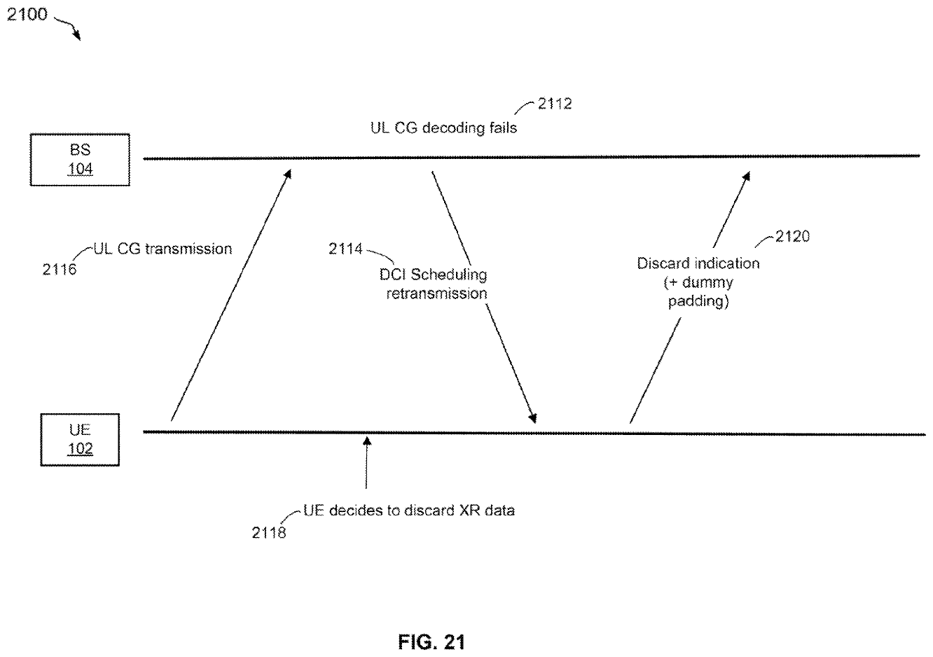

Referring next to FIG. 21, and in a scenario 2100, the UE 102 transmits 2116 UL CG transmission to the BS 104 (or a similar network entity in general). The UE 102 decides 2118 to discard XR data (e.g., due to congestion, delay, or other bandwidth issues). The BS 104 fails 2112 to decode the UL CG and sends 2114 a DCI scheduling retransmission to the UE 102. The UE 102 then transmits 2120 to the base station 104 a discard indication in the CG-UCI with dummy PUSCH as a padding. The base station 104 decodes the CG-UCI and ignores the remaining PUSCH. The base station aborts the HARQ process and removes the buffered data of the initial transmission.

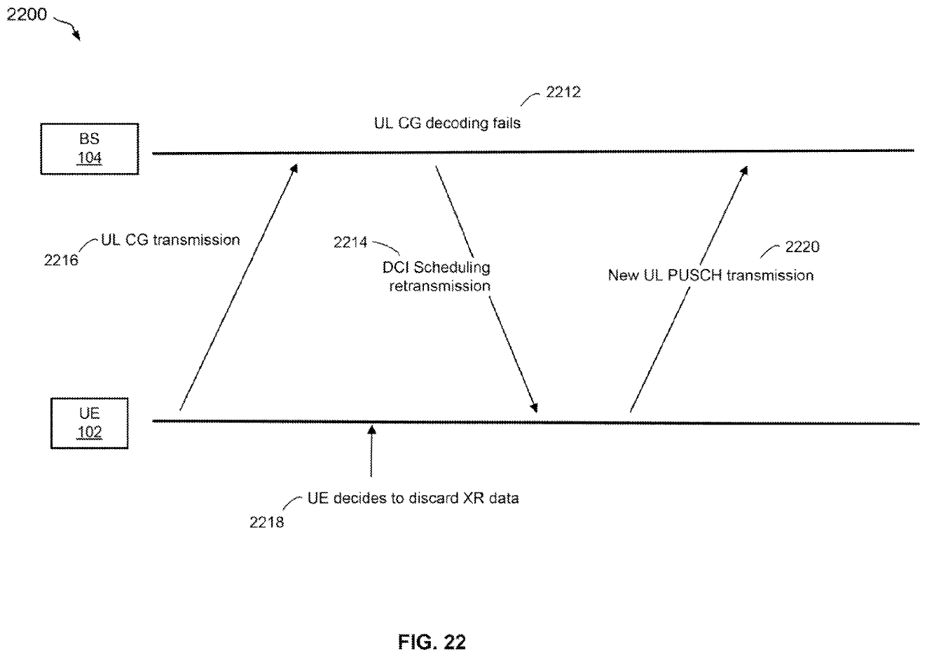

Referring next to the scenario 2200 of FIG. 22, the UE 102 transmits 2216 UL CG transmission to the BS 104. The UE 102 decides 2218 to discard XR data. The BS 104 fails 2212 to decode the UL CG and sends 2214 a DCI scheduling retransmission to the UE 102. The UE 102 may use the scheduled retransmission resources to transmit 2220 to the base station 104 a new data as shown. In some cases, the UE 102 may indicate in a CG-UCI or MAC CE that the data consists of a new data, e.g., 3GPP specifications may introduce an NDI (New Data Indicator) bit-field in the UCI for this purpose and the UE 102 may toggle this field to indicate a new data. The UE may encode the information in the UL DMRS, e.g., vis using phase shift, however this requires blind decoding from base station to check different possibilities every time. In other variant, the UE transmits UL DMRS in different time/frequency resources so that base station may tell if it is a new transmission or retransmission by detecting the location of DMRS signals.

To avoid this issue above, the UE 102 may transmit data on a CG resource and indicates (e.g., via CG-UCI or MAC CE) that there is no retransmission expected for this transmission as that it may discard the data straight away. If the granularity of the discard operation is the PDU set, the UE may signal the PDU Set discarding in the CG-UCI or on PUCCH UCI or on MAC CE. The base station 104 may interpret the discarding as releasing the remaining CG resources required initially for the PDU Set transmission

The base station 104 may use multi-PUSCH scheduling to adjust the configuration of all the PUSCHs occasions (MCS, FDRA (RB allocation), TDRA, . . . ) in a CG period for example after receiving CSI feedback or after a PUSCH decoding failure. The base station 104 may address the DCI scheduling multi-PUSCH to CG-RNTI.

The base station 104 may use multi-PUSCH scheduling to schedule PUSCH occasions in a CG period. In one embodiment, the multi-PUSCH scheduling may implicitly cancel the remaining CG-PUSCH occasions in the CG period.

CG transmission automatically starts a retransmission timer, the UE 102 needs then to monitor for PDCCH for any possible retransmission. Always monitoring for retransmission may be power consuming and not very beneficial especially for latency stringent traffic like XR UL pose/control information which might not require a retransmission as it may anyway exceed the delay budget. A retransmission-less CG has been discussed in 3GPP RAN1#110b where a CG configuration may be configured without retransmissions. A possible implementation to support retransmission-less CG is to configure one or some of the retransmission timers to zero. For example, drx-RetransmissionTimerUL or/and cg-RetransmissionTimer- may be set to zero in a the DRX-Config or/and in ConfiguredGrantConfig. In another embodiment, a dedicated field may be added under DRX-Config or/and ConrguredGrantConig to explicitly cancel the retransmissions. In another embodiment, the drx-RetransmissionTimerUI, or/and cg-RetransmissionTimer may be omitted from DRX-Config or/and in ConfiguredGrantConfig to indicate that the base station 104 has disabled the retransmission for the CG. In another embodiment, the UE 102 may indicate in a MAC CE that it doesn't need a retransmission for the current transmission. The base station 104 may signal the retransmission timers dynamically in the CG activation DCI or any other DCI.

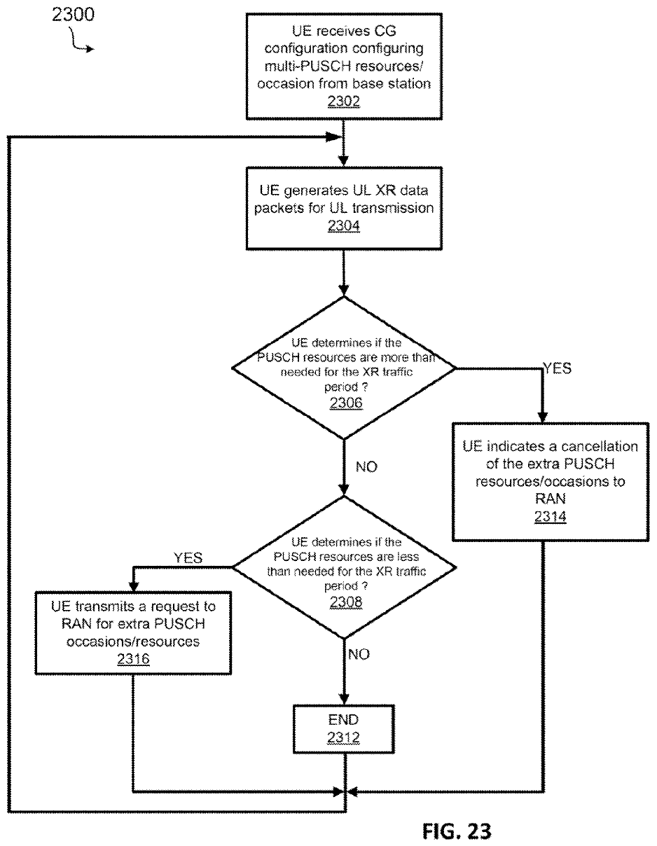

FIG. 23 illustrates a method 2300, which may be implemented/performed by a UE (e.g., the UE 102). The method 2300 begins at block 2302, where the UE receives at least one CG configuration configuring multiple PUSCH resources/occasions from a RAN (e.g., the base station 104). At block 2304, the UE generates UL XR data packets for UL transmission. At block 2306, the UE determines whether the PUSCH resources/occasions are more than what the UE needs to accommodate the XR data packets during a specific XR traffic period. If the UE determines that the PUSCH resources/occasions are more than what the UE needs, the flow proceeds to block 2314. At block 2314, the UE transmits a cancellation indication 2314 requesting or indicating cancellation of some of the PUSCH resources/occasions to the RAN. In some implementations, the cancellation indication is carried in a GC UCI, PUCCH UCI or MAC CE as described above. In other implementations, the cancellation indication is a RRC message (e.g., UEAssistanceInformation message). Otherwise, the flow proceeds to block 2308. At block 2308, the UE determines whether the PUSCH resources/occasions are less than what the UE needs to accommodate the XR data packets during a specific XR traffic period. If the UE at block 2308 determines that the PUSCH resources/occasions are less than the UE needs, the flow proceeds to block 2316. At block 2316, the UE transmits a request to the RAN to request extra PUSCH occasions/resources. In some implementations, the UE transmits the request on a PUCCH or PUSCH. For example, the request is carried in a CG-UCI or a PUCCH UCI. In another example, the request is a MAC CE. In yet another implementation, the request is a RRC message (e.g., UEAssistanceInformation message). Otherwise, if the UE at block 2308 determines that the PUSCH resources/occasions fulfil the UE needs, the flow proceeds to block 2312, where the flow ends.

In some implementations, the RAN may transmit to the UE a first configuration to allow the UE to transmit a cancellation indication. For example, the RAN transmits a first RRC message (e.g., RRCReconfiguration message or RRCResume message) including the first configuration to the UE. If the UE does not receive the first configuration, the UE refrains from transmitting to the RAN a cancellation indication requesting or indicating cancellation of PUSCH occasions/resources. In other implementations, the RAN may transmit to the UE a second configuration to allow the UE to transmit a request for extra PUSCH occasions/resources. For example, the RAN transmits a second RRC message (e.g., RRCReconfiguration message or RRCResume message) including the first configuration to the UE. If the UE does not receive the second configuration, the UE refrains from transmitting to the RAN a request to demand extra PUSCH resources/occasions. In some implementations, the first and second configurations are the same configuration (i.e., the same instance). In other implementations, the first and second configurations are different configurations. In some implementations, the first and second RRC messages are the same RRC messages (e.g., the same instance or different instances). In other implementations, the first and second RRC messages are different messages. The following description may be applied to the description above.

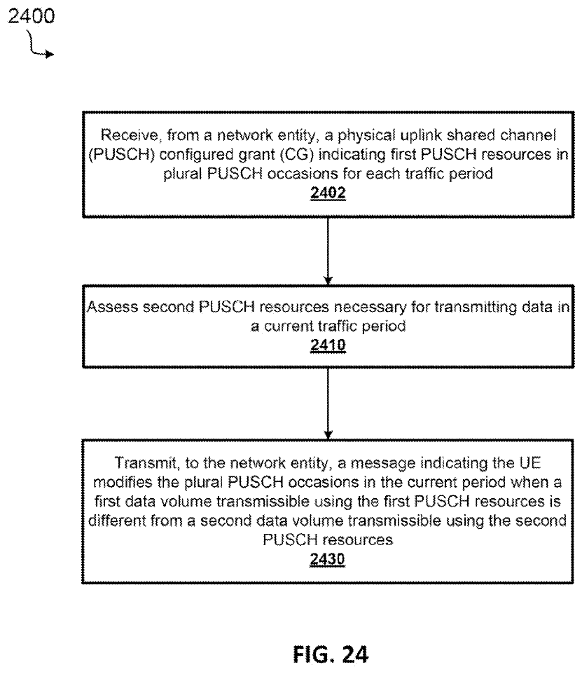

FIG. 24 is a flow diagram 2400 depicting a method by a UE device (such as the UE 102), according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof.

As shown in the flow diagram 2400, the UE receives 2402, from a network entity, a physical uplink shared channel (PUSCH) configured grant (CG) indicating first PUSCH resources in plural PUSCH occasions for each traffic period. The UE assesses 2410 second PUSCH resources necessary for transmitting data in a current traffic period. The UE transmits 2430, to the network entity, a message indicating the UE modifies the plural PUSCH occasions in the current period when a first data volume transmissible using the first PUSCH resources is different from a second data volume transmissible using the second PUSCH resources.

In aspects, the message is a request for additional PUSCH resources in at least one additional PUSCH occasion when the second data volume is larger than the first data volume. In some cases, the request for the additional PUSCH resources includes one or more of: a number of extra PUSCH occasions; a number of upcoming traffic periods to include the extra PUSCH occasions; and an uplink control information (UCI) bit field identifying one or more PUSCH occasions to be added to the plural PUSCH occasions.

In aspects, the message is an indication of releasing a subset of the first PUSCH resources in at least one among the PUSCH occasions when the second data volume is larger than the first data volume. In some cases, the indication comprises at least one of: an uplink control information (UCI) bit field identifying the at least one among the PUSCH occasions; an index or identifier of a cutoff PUSCH occasion, wherein the at least one PUSCH occasion follow the cutoff PUSCH occasion; an index or identifier of a slot, wherein PUSCH occasions starting after the slot are released; a number of PUSCH occasions kept after the indication, wherein PUSCH occasions subsequent to the number of PUSCH occasions are released; an index of a first PUSCH occasion to be canceled, the index being relative to a PUSCH sending the indication; or an index of a final PUSCH occasion to be used.

In aspects, the UE receives the PUSCH CG via radio resource control (RRC) signaling.

In aspects, wherein the PUSCH CG configures the plural PUSCH occasion to have at least two different offset intervals therebetween.

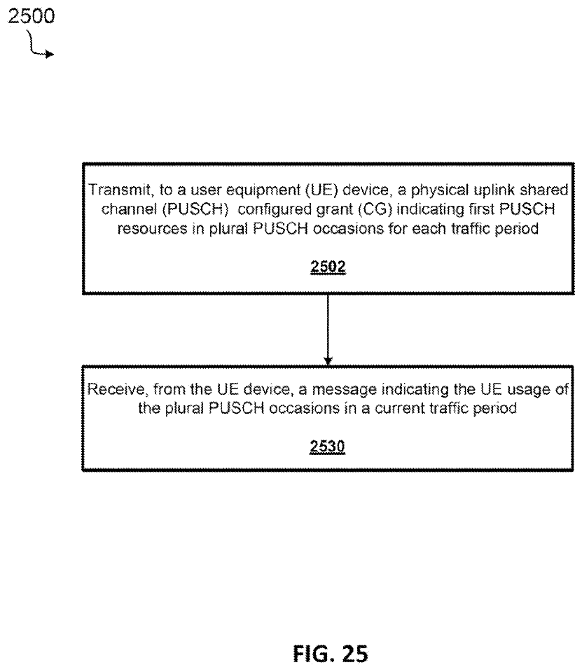

FIG. 25 is a flow diagram 2500 depicting a method by network entity (such as the base station 106), according to some embodiments. The method is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof.

As shown in the flow diagram 2500, the network entity transmits 2502 to a UE device, a PUSCH CG indicating first PUSCH resources in plural PUSCH occasions for each traffic period. The network entity receives 2530, from the UE device, a message indicating the UE usage of the plural PUSCH occasions in a current traffic period. For example, in some cases, the message modifies the plural PUSCH occasions in a current traffic period as a first data volume transmissible using the first PUSCH resources is different from a second data volume that the UE device needs to transmit in a current traffic period.

Generally speaking, description for one of the above figures may apply to another of the above figures. Examples, implementations and methods described above may be combined, if there is no conflict. An event or block described above may be optional or omitted. For example, an event or block with dashed lines in the figures may be optional. In some implementations, “message” is used and may be replaced by “information element (IE)”, and vice versa. In some implementations, “IE” is used and may be replaced by “field”, and vice versa. In some implementations, “configuration” may be replaced by “configurations” or “configuration parameters”, and vice versa.

A user device in which the techniques of this disclosure may be implemented (e.g., the UE 102) may be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device may operate as an internet-of-things (IoT) device or a mobile-internet device (MID). Depending on the type, the user device may include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module may comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques may be provided as part of the operating system, a library used by multiple applications, a particular software application, etc. The software may be executed by one or more general-purpose processors or one or more special-purpose processors.

Upon reading this disclosure, those of skill in the art may appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which may be apparent to those of ordinary skill in the art, may be made in the arrangement, operation and details of the method and apparatus disclosed herein without departing from the spirit and scope defined in the appended claims.

### Example Aspects

Example 1. A method of wireless communications by a user equipment (UE) device, the method comprising:
   receiving, from a network entity, a physical uplink shared channel (PUSCH) configured grant (CG) indicating first PUSCH resources in plural PUSCH occasions for each traffic period;
   assessing second PUSCH resources necessary for transmitting data in a current traffic period; and
   transmitting, to the network entity, a message indicating the UE modifies the plural PUSCH occasions in the current period when a first data volume transmissible using the first PUSCH resources is different from a second data volume transmissible using the second PUSCH resources.
Example 2. The method of Example 1, wherein the message is a request for additional PUSCH resources in at least one additional PUSCH occasion when the second data volume is larger than the first data volume.
Example 3. The method of Example 2, wherein the request for the additional PUSCH resources comprises one or more of:
   a number of extra PUSCH occasions;
   a number of upcoming traffic periods to include the additional PUSCH occasions; and
   an uplink control information (UCI) bit field identifying one or more PUSCH occasions to be added to the plural PUSCH occasions.
Example 4. The method of Example 1, wherein the message is an indication of releasing a subset of the first PUSCH resources in at least one among the PUSCH occasions when the second data volume is larger than the first data volume.
Example 5. The method of Example 3, wherein the indication comprises at least one of:
   an uplink control information (UCI) bit field identifying the at least one among the PUSCH occasions;
   an index or identifier of a cutoff PUSCH occasion, wherein the at least one PUSCH occasion follow the cutoff PUSCH occasion;
   an index or identifier of a slot, wherein PUSCH occasions starting after the slot are released;
   a number of PUSCH occasions kept after the indication, wherein PUSCH occasions subsequent to the number of PUSCH occasions;
   an index of a first PUSCH occasion to be canceled, the index being relative to a PUSCH sending the indication; or
   an index of a final PUSCH occasion to be used.
Example 6. The method of Example 1, wherein the UE receives the PUSCH CG via radio resource control (RRC) signaling.
Example 7. The method of Example 1, wherein the PUSCH CG configures the plural PUSCH occasion to have at least two different offset intervals therebetween.
Example 8. A method of wireless communications by a network entity, the method comprising:
   transmitting, to a user equipment (UE) device, a physical uplink shared channel (PUSCH) configured grant (CG) indicating first PUSCH resources in plural PUSCH occasions for each traffic period; and
   receiving, from the UE device, a message indicating the UE modifies the plural PUSCH occasions in a current traffic period as a first data volume transmissible using the first PUSCH resources is different from a second data volume that the UE device needs to transmit in a current traffic period.
Example 9. The method of Example 8, wherein the message is a request for additional PUSCH resources in at least one additional PUSCH occasion when the second data volume is larger than the first data volume.
Example 10. The method of Example 9, wherein the request for the additional PUSCH resources comprises one or more of:
   a number of extra PUSCH occasions;
   a number of upcoming traffic periods to include the additional PUSCH occasions; and
   an uplink control information (UCI) bit field identifying one or more PUSCH occasions to be added to the plural PUSCH occasions.
Example 11. The method of Example 8, wherein the message is an indication of releasing a subset of the first PUSCH resources in at least one among the PUSCH occasions when the second data volume is larger than the first data volume.
Example 12. The method of Example 10, wherein the indication comprises at least one of:
   an uplink control information (UCI) bit field identifying the at least one among the PUSCH occasions;
   an index or identifier of a cutoff PUSCH occasion, wherein the at least one PUSCH occasion follows the cutoff PUSCH occasion;
   an index or identifier of a start-release PUSCH occasion among the plural PUSCH occasions, wherein the at least one PUSCH occasions start after the PUSCH occasion;
   a number of PUSCH occasions used after one of the plural PUSCH occasions used to send the indication, wherein PUSCH resources of remaining PUSCH occasions are released;
   an index of a first PUSCH occasion among a subset of PUSCH occasion whose PUSCH resources are released, the index being relative to one of the PUSCH occasion used for sending the indication; or
   an index of a last PUSCH occasion among the plural PUSCH occasions that is used.
Example 13. The method of Example 8, wherein the UE receives the PUSCH CG via radio resource control (RRC) signaling.
Example 14. The method of Example 8, wherein the PUSCH CG configures the plural PUSCH occasion to have at least two different offset intervals there-between.
Example 15. An apparatus for wireless communications, comprising:
   a processor coupled to the one or more RF modems; and
   at least one memory storing executable instructions, the executable instructions to manipulate at least one of the processor or the one or more RF modems to perform the method of any of Examples 1-14.

1-17. (canceled)

18. A method of wireless communications by a user equipment (UE), the method comprising:
receiving, from a network entity, a physical uplink shared channel (PUSCH) configured grant (CG), indicating first PUSCH resources in plural PUSCH occasions for each CG period; and
transmitting, to the network entity, a message including an uplink control information (UCI) bit field comprising a bitmap indicating UE usage of the plural PUSCH occasions in a current CG period.

19. The method of claim 18, wherein the message comprises one or more of:
a number of extra PUSCH occasions;
a number of upcoming traffic periods to include an additional PUSCH occasion including additional PUSCH resources; or
the UCI bit field identifying one or more PUSCH occasions to be added to the plural PUSCH occasions.

20. The method of claim 19, wherein the bitmap has a length corresponding to a number of PUSCH occasions in each traffic period.

21. The method of claim 19, wherein the bitmap has a length corresponding to a number of PUSCH occasions in a CG cycle.

22. The method of claim 18, wherein the PUSCH CG further indicates a number of bits in the bitmap using a radio resource control (RRC) parameter and wherein the bitmap comprises a plurality of values indicating whether a PUSCH occasion is to be used or unused.

23. The method of claim 19, wherein the UCI bit field comprises at least one of:
a PUSCH cancellation indication indicating a number of PUSCH occasions configured in each traffic period;
a PUSCH cancellation indication indicating a number of PUSCH occasions configured in a CG cycle; or
a PUSCH request indication indicating a parameter of a maximum number of PUSCH occasions.

24. The method of claim 18, wherein transmitting the message is condition upon when a first data volume transmissible using the first PUSCH resources for each traffic period is different from a second data volume transmissible using second PUSCH resources assessed by the UE for transmitting data in the current CG period, and wherein the message is a request for additional PUSCH resources in an additional PUSCH occasion when the second data volume is larger than the first data volume.

25. The method of claim 18, wherein transmitting the message is condition upon when a first data volume transmissible using the first PUSCH resources for each traffic period is different from a second data volume transmissible using second PUSCH resources assessed by the UE for transmitting data in the current CG period, and wherein the message is an indication of releasing a subset of the first PUSCH resources in at least one among the PUSCH occasions when the second data volume is smaller than the first data volume.

26. The method of claim 25, wherein the indication comprises at least one of:
the UCI bit field identifying the at least one among the PUSCH occasions;
an index or identifier of a cutoff PUSCH occasion, wherein the at least one PUSCH occasion follows the cutoff PUSCH occasion;
an index or identifier of a slot, wherein PUSCH occasions starting after the slot are released;
a number of PUSCH occasions kept after the indication, wherein PUSCH occasions subsequent to the number of PUSCH occasions are released;
an index of a first PUSCH occasion to be canceled, the index being relative to a PUSCH sending the indication; or
an index of a final PUSCH occasion to be used.

27. A method of wireless communications by a network entity, the method comprising:
transmitting, to a user equipment (UE), a physical uplink shared channel (PUSCH) configured grant (CG) indicating PUSCH resources in plural PUSCH occasions for each CG period; and
receiving, from the UE, a message including an uplink control information (UCI) bit field comprising a bitmap indicating UE usage of the plural PUSCH occasions in a current CG period.

28. The method of claim 27, wherein the message is an indication of releasing a subset of the PUSCH resources in at least one among the plural PUSCH occasions.

29. The method of claim 28, wherein the UCI bit field identifies the at least one among the plural PUSCH occasions and wherein the bitmap has a length corresponding to a number of PUSCH occasions in each traffic period or a CG cycle.

30. The method of claim 27, wherein the bitmap comprises a plurality of values indicating whether a PUSCH occasion is to be used or unused; and wherein the PUSCH CG further indicates a number of bits in the bitmap using a radio resource control (RRC) parameter.

31. The method of claim 28, wherein the indication comprises at least one of:
an index or identifier of a cutoff PUSCH occasion, wherein the at least one among the plural PUSCH occasions follows the cutoff PUSCH occasion;
an index or identifier of a start-release PUSCH occasion among the plural PUSCH occasions, wherein the at least one among the plural PUSCH occasions start after the start-release PUSCH occasion;
a number of PUSCH occasions used after one of the plural PUSCH occasions used to send the indication, wherein PUSCH resources of remaining PUSCH occasions are released;
an index of a first PUSCH occasion among a subset of PUSCH occasion whose PUSCH resources are released, the index being relative to one of the PUSCH occasion used for sending the indication;
an index of a last PUSCH occasion among the plural PUSCH occasions that is used; or
the UCI bit field identifying the at least one among the plural PUSCH occasions, wherein the UCI bit field comprises at least one of:
a PUSCH cancellation indication indicating a number of PUSCH occasions configured in each traffic period or a CG cycle; or
a PUSCH request indication indicating a parameter of a maximum number of PUSCH occasions.

32. The method of claim 27, wherein the message is a request for additional PUSCH resources in at least one additional PUSCH occasion.

33. The method of claim 27, wherein the PUSCH CG configures the plural PUSCH occasion to have at least two different offset intervals therebetween.

34. An apparatus for wireless communications, comprising:
one or more radio frequency (RF) modems;
a processor coupled to the one or more RF modems; and
at least one memory storing executable instructions, the executable instructions to manipulate at least one of the processor or the one or more RF modems to:
receive, from a network entity, a physical uplink shared channel (PUSCH) configured grant (CG), indicating first PUSCH resources in plural PUSCH occasions for each CG period; and
transmit, to the network entity, a message including an uplink control information (UCI) bit field comprising a bitmap indicating UE usage of the plural PUSCH occasions in a current CG period.

35. The apparatus of claim 34, wherein the message comprises one or more of:
a number of extra PUSCH occasions;
a number of upcoming traffic periods to include an additional PUSCH occasion including additional PUSCH resources; or
the UCI bit field identifying one or more PUSCH occasions to be added to the plural PUSCH occasions.

36. The apparatus of claim 35, wherein the bitmap has a length corresponding to a number of PUSCH occasions in each traffic period.

37. The apparatus of claim 35, wherein the bitmap has a length corresponding to a number of PUSCH occasions in a CG cycle.
